(19) United States
(12) Patent Application Publication
(10) Pub. No.: US 2017/0041470 A1
(43) Pub. Date: Feb. 9, 2017

(54) SYSTEM, DEVICE, METHOD, SOFTWARE APPLICATION AND DATA SIGNAL FOR MONITORING AN INTERACTION

(71) Applicant: ICHARGEYOU PTY LTD, North Sydney (AU)

(72) Inventor: Brett MCAULIFFE, North Sydney (AU)

(21) Appl. No.: 15/303,489

(22) PCT Filed: Apr. 10, 2015
(86) PCT No.: PCT/AU2015/050166

§ 371 Date: Oct. 11, 2016

(30) Foreign Application Priority Data
Apr. 11, 2014 (AU) 2014901339

(51) Int. Cl. H04M 15/00; G06Q 30/04

(52) U.S. Cl. CPC H04M 15/62; G06Q 30/04; H04M 15/41; H04M 15/8278

(57) ABSTRACT

The present invention provides a system, device, method, software program and data signal for monitoring an interaction. The device includes a trigger detection module arranged to monitor events on a hardware device to determine a trigger for an event. On determining the trigger for the event, the trigger detection module invokes a timer module arranged to monitor for completion of the event. Upon completion of the event, the timer module records the total time of the event in an event record.

### TECHNICAL FIELD/FIELD OF THE INVENTION

The present invention relates to a system, device, method, software application and data signal for monitoring an interaction and in particular, to a system, method, software application and data signal that is capable of determining the identity of a caller on a mobile (cell) telephone, with a view to recording information about aspects of the interaction between the caller and the callee.

The invention has been developed for users who provide a professional service, where it is necessary for a professional (such as a lawyer, accountant, financial planner or advisor/consultant) to keep track of the time they spend speaking to clients, the broader inventive concept will be described hereinafter with reference to this application. However, it will be appreciated that the invention is not limited to this particular field of use.

### BACKGROUND ART

The following discussion of the background art is intended to facilitate an understanding of the present invention only. The discussion is not an acknowledgement or admission that any of the material referred to is or was part of the common general knowledge as at the priority date of the application.

Many professionals, such as lawyers, accountants and patent attorneys work on an hourly rate. That is, they bill a client based on how much time they spend interacting with a client or working on a matter for a client. Lawyers, accountants and other professionals are required to keep very accurate and detailed records of the time they spend with clients, not only for billing purposes, but also because it is necessary, in some instances, to be able to determine (say, in a legal dispute over charges), the exact amount of time spent with a client or working on a client's matters.

With the advent of mobile phones (including mobile data), Wireless Internet connections, small portable devices such as ‘smartphones’ and ‘tablet computers’, many professionals now work away from a traditional office environment, and typically receive calls or emails at any time of the day or night. Such calls are harder to track because they generally occur away from an office environment (sometimes when a professional is not working, but is at home, in transit or engaged in a social activity).

### SUMMARY OF INVENTION

In a first aspect, the present invention provides a device for monitoring an interaction, comprising an identification module arranged to monitor events on a hardware device to determine a trigger for an event, wherein, on determining the trigger for the event, a timer module is arranged to monitor for completion of the event, and upon completion of the event, the timer module records the total time of the event in an event record.

The device may further include an identification module arranged to identify a party associated with the event, wherein, upon completion of the event, information regarding the party associated with the event is recorded in the event record.

The timer module may further record at least one of a start time for the event, and end time for the event, a start date of the event and an end date of the event in the event record.

The identification module may also identify a reference identifier associated with the party, wherein, upon completion of the event, the reference associated with the party is recorded in the event record.

The identification module may identify a plurality of reference identifiers associated with a party and provides the reference identifiers to a user of the device, wherein upon selection of one or more of the plurality of reference identifiers by the user, the identification module associates and records the one or more reference identifiers in the event record.

The device may further include a charge module arranged to utilise information recorded by the timer module to generate an amount of billable time, wherein the billable time is recorded and associated with the event record.

The device may further include an invoicing module arranged to utilise the billable time recorded in the event record to generate an invoice. The invoicing module may be arranged to forward, via a communications module, the invoice to a remote device.

The device may further include a human machine interface arranged to allow a user of the device to interact with the device. The human machine interface may be a touchscreen.

The device may be a mobile communications device, such as a smartphone.

In a second aspect, there is provided a system for monitoring an interaction, comprising a device including an trigger detection module arranged to monitor events on a hardware device to determine a trigger for an event, wherein, on determining the trigger for the event, the trigger detection module invokes a timer module arranged to monitor for completion of the event, and upon completion of the event, the timer module records the total time of the event in an event record.

In a third aspect, there is provided a method for monitoring an interaction, comprising the steps of using a trigger detection module to monitor events on a hardware device to determine a trigger for an event, wherein, on determining the trigger for the event, the trigger detection module invokes a timer module arranged to monitor for completion of the event, and upon completion of the event, the timer module records the total time of the event in an event record.

In a fourth aspect, there is provided a software application including at least one instruction which, when executed on a computing system, causes the computing system to carry out the method in accordance with the third aspect of the invention.

In a fifth aspect, there is provided a data signal including at least one encoded instruction which, when received and executed by a computing system, causes the computing system to carry out the method in accordance with the third aspect of the invention.

### BRIEF DESCRIPTION OF THE DRAWINGS

Notwithstanding any other embodiments that may fall within the scope of the present invention, an embodiment of the present invention will now be described, by way of example only, with reference to the accompanying figures, in which:

FIG. 1 is an example computing system and network that may be utilised to operate a system, method and/or software application in accordance with the present invention;

FIG. 2 is a screenshot displaying a login screen in accordance with an embodiment of the invention;

FIG. 3 is a screenshot displaying a summary screen in accordance with an embodiment of the invention;

FIG. 4 is a screenshot displaying a simplified screen in accordance with an embodiment of the invention;

FIG. 5 is a screenshot displaying a name list screen in accordance with an embodiment of the invention;

FIG. 6 is a screenshot displaying a name list screen including matter numbers in accordance with an embodiment of the invention;

FIG. 7 is a screenshot displaying a matter number screen in accordance with an embodiment of the invention;

FIG. 8 is a screenshot displaying a live matter screen in accordance with an embodiment of the invention;

FIG. 9 is a screenshot displaying a live matter screen in accordance with an embodiment of the invention;

FIG. 10 is a screenshot displaying a confirmation screen in accordance with an embodiment of the invention;

FIG. 11 is a screenshot displaying a phone book list screen in accordance with an embodiment of the invention;

FIGS. 12A to 12D are screenshots displaying a recording screen in accordance with an embodiment of the invention;

FIGS. 13A to 13C are screenshots displaying summary screens in accordance with an embodiment of the invention;

FIG. 14 is a screenshot displaying an export screen in accordance with an embodiment of the invention;

FIG. 15 is a screenshot displaying a forwarding screen in accordance with an embodiment of the invention;

FIGS. 16A to 16G are screenshots displaying verification screens in accordance with an embodiment of the invention;

FIG. 17 is a screenshot displaying a currency translation screen in accordance with an embodiment of the invention;

FIG. 18 is a screenshot displaying a setup screen in accordance with an embodiment of the invention;

FIG. 19 is a screenshot displaying a setup screen in accordance with an embodiment of the invention;

FIG. 20 is a screenshot displaying a setup screen in accordance with an embodiment of the invention;

FIG. 21 is a screenshot displaying a covering letter screen in accordance with an embodiment of the invention;

FIGS. 22A and 22B are screenshots displaying statement of account screens in accordance with an embodiment of the invention;

FIG. 23 is a screenshot displaying a rate determination screen in accordance with an embodiment of the invention;

FIGS. 24A, 24B and 24C are screenshots displaying rate set-up screens in accordance with an embodiment of the invention;

FIG. 25 is a screenshot displaying an export screen in accordance with an embodiment of the invention;

FIG. 26 is a screenshot displaying a feedback screen in accordance with an embodiment of the invention;

FIG. 27 is a screenshot displaying a target screen in accordance with an embodiment of the invention;

FIG. 28 is a screenshot displaying a target screen in accordance with an embodiment of the invention;

FIG. 29 is a screenshot displaying an export screen in accordance with an embodiment of the invention;

FIG. 30 is a screenshot displaying a backup screen in accordance with an embodiment of the invention;

FIG. 31 is a screenshot displaying a referrer screen in accordance with an embodiment of the invention;

FIG. 32 is a screenshot displaying an import screen in accordance with an embodiment of the invention;

FIGS. 33A to 33C are screenshots displaying settings screens in accordance with an embodiment of the invention;

FIGS. 34A and 34B are screenshots displaying different rates for different times and days of the week screen, in accordance with an embodiment of the invention;

FIGS. 35A and 35B are screenshots displaying calendar settings for the automated scheduled sending, of invoices and client history, and the settings for recording and storing voice command and gesture/accelerometer command settings screens, in accordance with an embodiment of the invention;

FIG. 36 is a screenshot displaying client and matter data reporting options screens, in accordance with an embodiment of the invention;

FIG. 37 is a screenshot displaying client and matter data reporting screens, in accordance with an embodiment of the invention;

FIGS. 38A and 38B are screenshots displaying client and matter data reporting screens, in accordance with an embodiment of the invention;

FIGS. 39A and 39B are screenshots displaying the specified period of data settings screens, in accordance with an embodiment of the invention;

FIGS. 40A and 40B are screenshots displaying the specified period of data comparing which amounts have been invoiced, to those which have not been invoiced settings screens, in accordance with an embodiment of the invention;

FIGS. 41A to 41C are screenshots displaying the client or matter specific settings screens, in accordance with an embodiment of the invention;

FIG. 42 is a screenshot displaying the custom iCY menu and navigation control settings screen, in accordance with an embodiment of the invention;

FIGS. 43 to 47 are schematic diagrams illustrating a controller or device in accordance with an embodiment of the invention; and

FIG. 48 is an illustration of a vehicle dashboard including an embedded application on a screen of the vehicle dashboard, in accordance with an embodiment of the invention.

### DESCRIPTION OF PREFERRED/SPECIFIC EMBODIMENTS

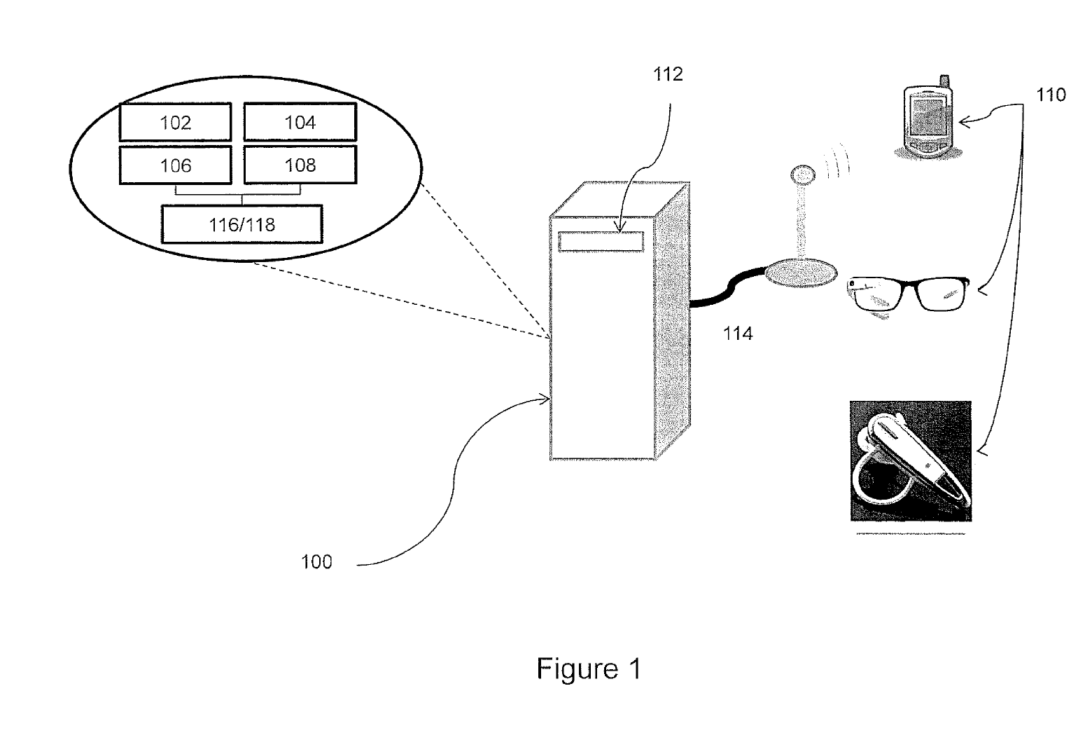

Referring to FIG. 1, an embodiment of the present invention is illustrated. This embodiment is arranged to provide a system for, comprising an interface for receiving input from a user and a processor for determining the amount of time spent on a phone call or composing an email, to thereby determine the amount the client should be billed. In this example embodiment, the interface and processor are implemented on a portable computing device (such as a smartphone or a tablet computer) having an appropriate user interface. The computing device is appropriately programmed to implement the invention.

In this embodiment, the application is self-contained, with all information being held by the computing device. In another embodiment, as explained under the heading “iCY controller”, there may be provide a system which includes a device (i.e. a ‘dongle’) which records information and then is capable of uploading the information to another device, such as a smart phone or a computing system. Moreover, in some embodiments, either the application or the device access a separately administered database containing relevant data, in order to generate the invoice.

In more detail, there is provided a system for monitoring an interaction. The system includes a device including an trigger detection module arranged to monitor events on a hardware device to determine a trigger for an event. On determining the trigger for the event, the trigger detection module invokes a timer module arranged to monitor for completion of the event. Upon completion of the event, the timer module records the total time of the event in an event record.

Embodiments of the invention also provide for a method for monitoring an interaction which may be implemented on any suitable device or any suitable system (i.e. two or more devices which operate as a system). The method comprises the steps of using a trigger detection module to monitor events on a hardware device to determine a trigger for an event. On determining the trigger for the event, the trigger detection module invokes a timer module arranged to monitor for completion of the event. Upon completion of the event, the timer module records the total time of the event in an event record.

Referring to FIG. 1 in more detail, there is a shown a schematic diagram of a central transfer system which in this embodiment comprises a server 100. The server 100 comprises suitable components necessary to receive, store and execute appropriate computer instructions. The components may include a processing unit 102, read only memory (ROM) 104, random access memory (RAM) 106, and input/output devices such as disk drives (including solid state drives or any other storage technology as used depending on the specific hardware/software combination) 108, input devices 110 such as a mobile (smart) phone, a Bluetooth™ device and/or another form of ‘smart’ device, such as Google Glass™. The server 100 includes instructions that may be included in ROM 104, RAM 106 or disk drives 108 and may be executed by the processing unit 102. There may be provided a plurality of communication links 114 which may variously connect to one or more computing devices such as a server, personal computers, terminals, wireless or handheld computing devices. At least one of a plurality of communications link may be connected to an external computing network through a wireless link (e.g. satellite), optical fibre, telephone line or other type of communications link.

The service may include storage devices such as a disk drive 108 which may encompass solid state drives, hard disk drives, optical drives or magnetic tape drives. The server 100 may use a single disk drive or multiple disk drives. The server 100 may also have a suitable operating system 116 which resides on the disk drive or in the ROM of the server 100.

In the ensuing description, for the sake of clarity, and in the context of the embodiment described, reference will be made to a “professional” (the person who is utilising the device and the software application) and a “client” (the person who is interacting, in the context of the examples and embodiments described herein, with the professional). However, it will be understood that these identifiers/labels are utilised only for the sake of providing a clear and easily understood example, and no gloss should be taken from these labels to limit the scope of any embodiments described, any features of any of the embodiments described, or the broader invention described herein.

Moreover, where a third party product is referred to in the ensuing description, the name of the product is marked with a “™” to denote a brand/mark. Where a brand name is used to describe a product, the intention of the writer is to provide a ‘real world’ example are utilised only for the sole purpose of providing a clear and easily understood example, and no gloss should be taken from these branded/marked examples to limit the scope of any embodiment, any feature of an embodiment, or the broader invention described herein.

The embodiment described herein, which is distributed under the trade mark “iChargeYou” or “iCY”, is a software application which, in the embodiment described herein, is an “app” (i.e. a software application that is specifically designed for use on a portable, handheld telecommunications device such as a smart phone or a tablet computing device). It will be understood that the portable device may communicate utilising any suitable technology (including but not limited to WiFi) and that any reference herein to a Subscriber Identification Module (SIM), 3^{rd} Generation (3G) and 4^{th} Generation (4G) and/or further generation telecommunications networks, or any other specific hardware or software, is provided for the purposes of illustration only and is not intended to limit the scope of the claimed invention.

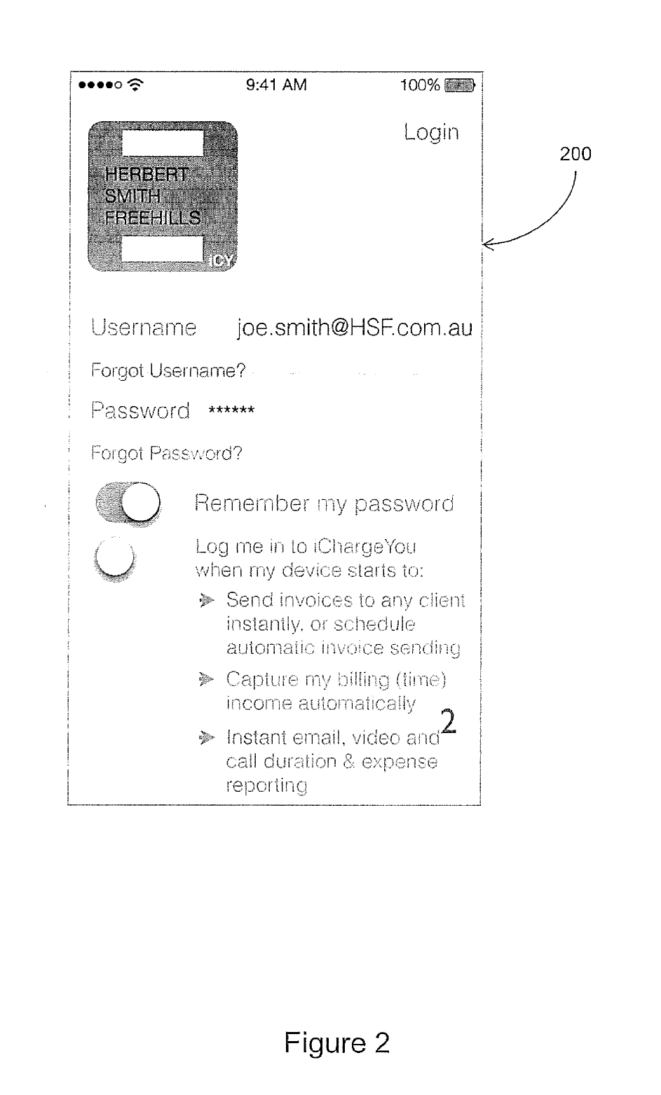

Example interface screen captures of an embodiment of the iCY app are shown in FIGS. 2 through 42 and are described in more detail hereinbelow.

It will be understood, however, that the iCY application may also be provided as a “desktop” software application for use on a personal computing device such as a laptop, a notebook computer or a personal computer, or may be provided in any appropriate form, as computing technology evolves. Such variations are within the purview of the person skilled in the art.

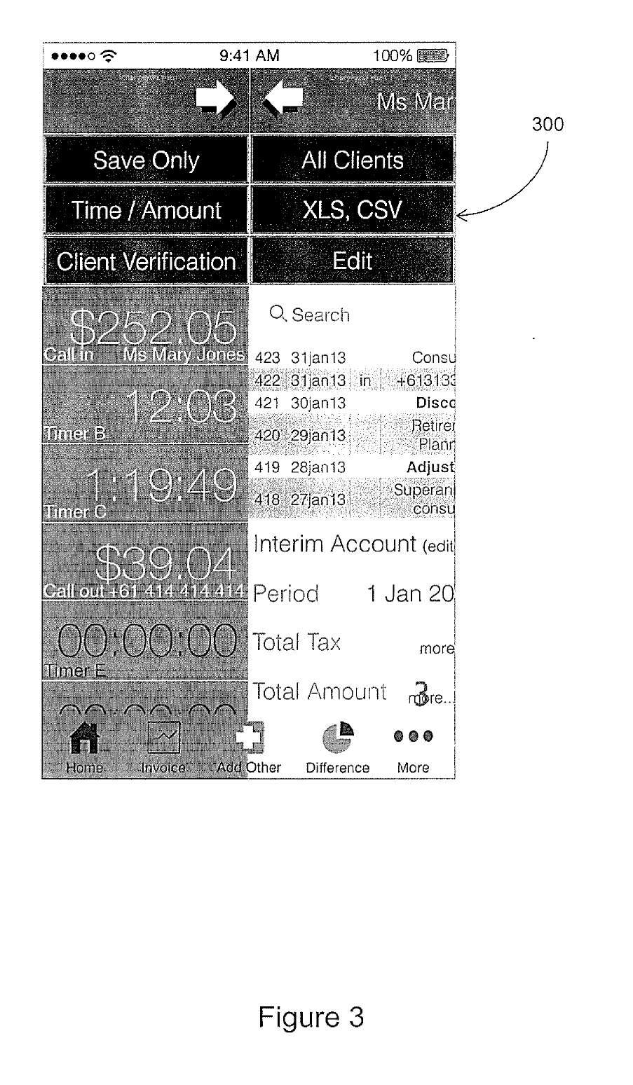

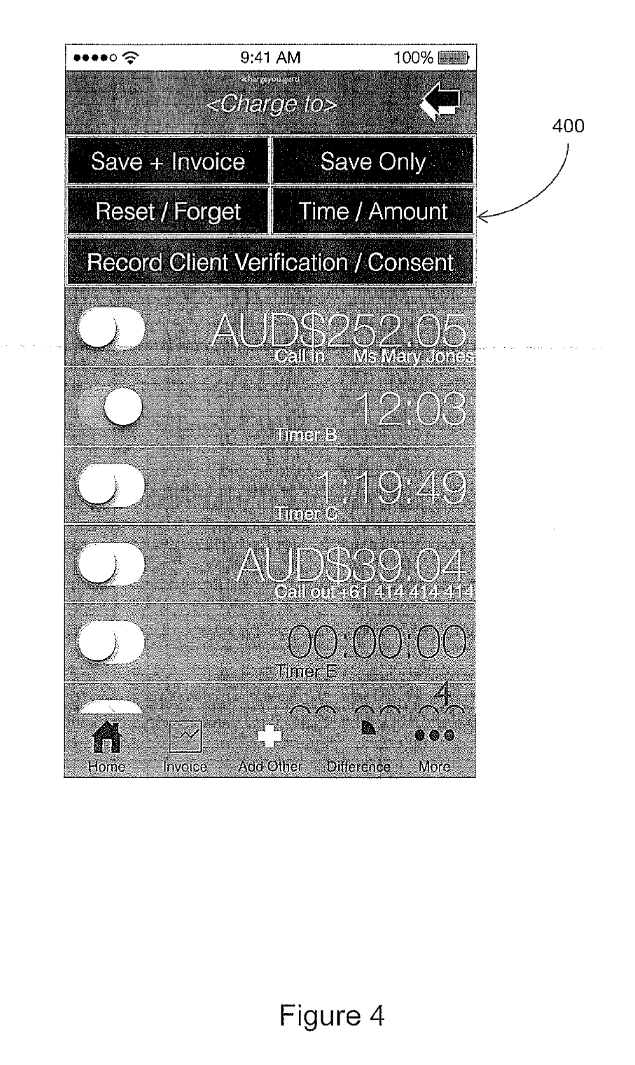

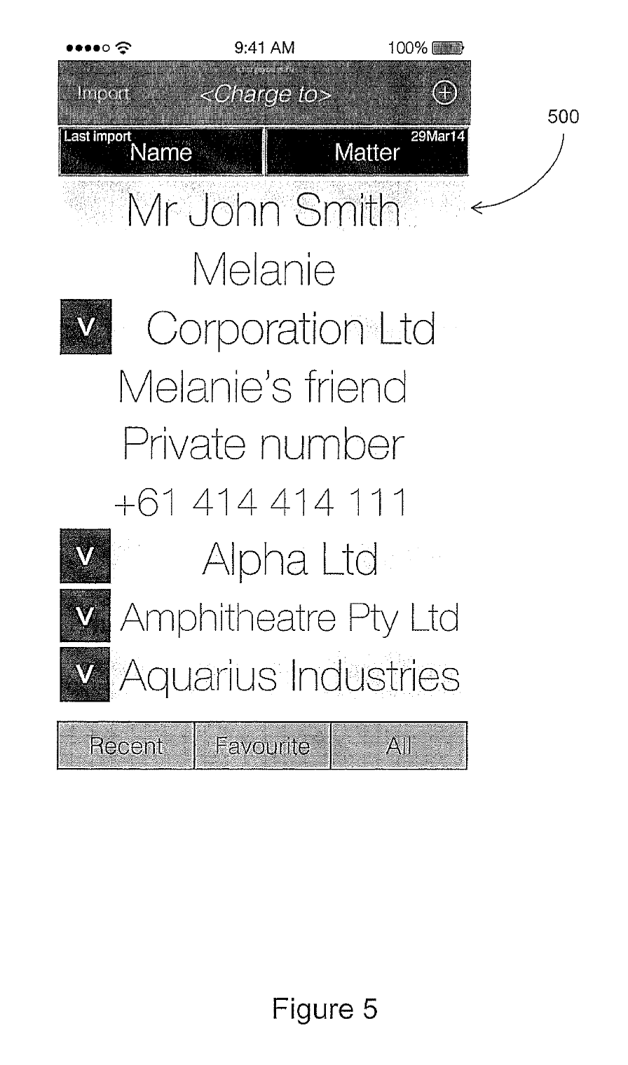

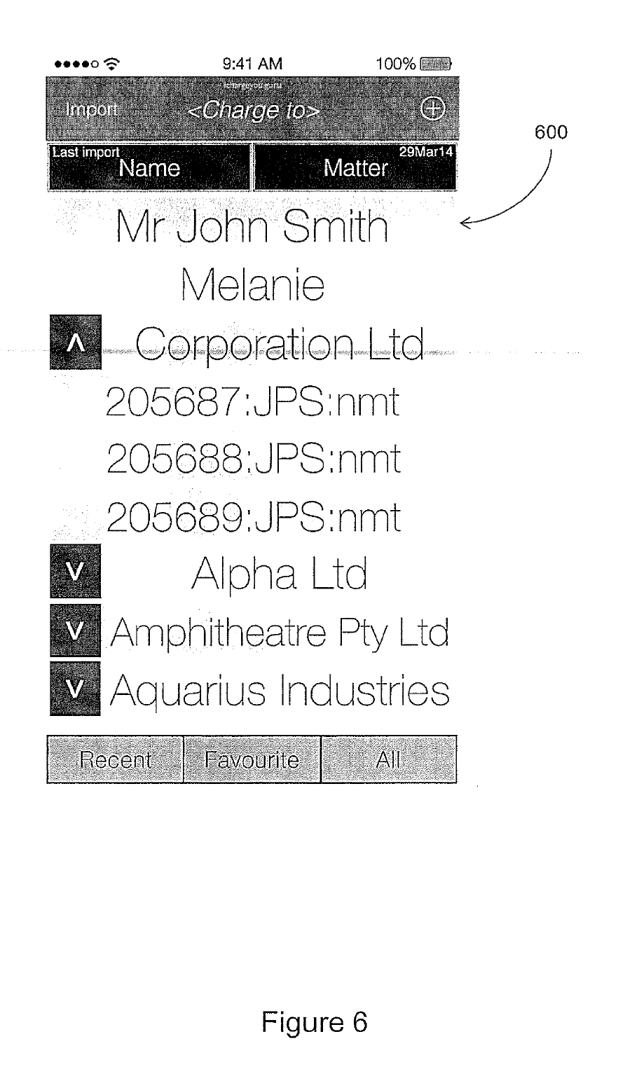

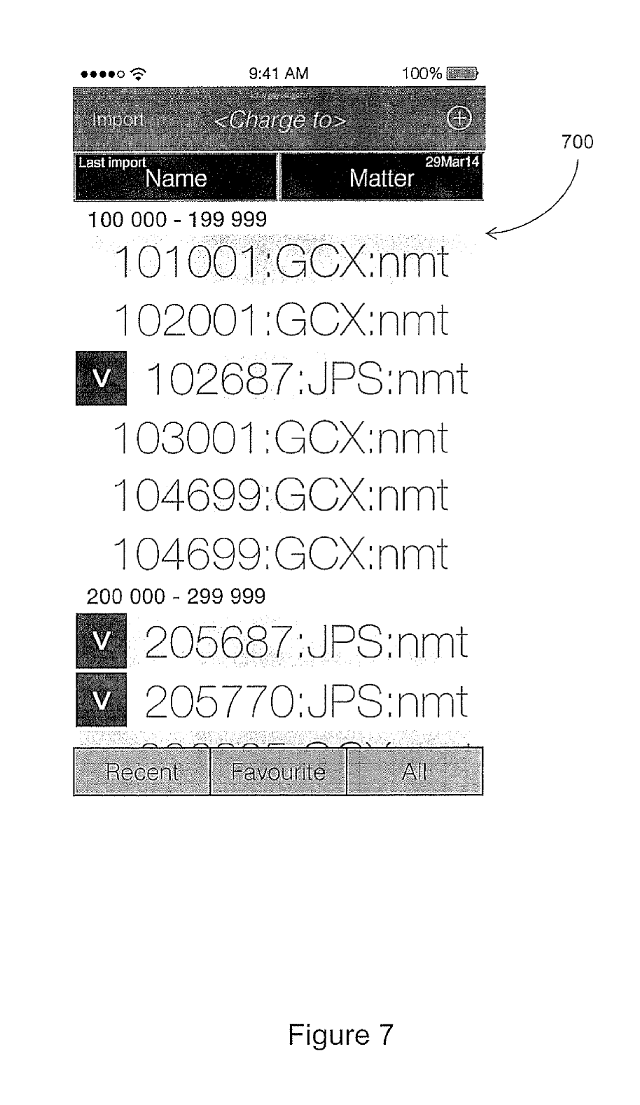

At FIG. 2, screen 200 provides a login screen to allow a user to log into the iCY app before use. The user is then presented with screen 300 at FIG. 3. FIG. 4 illustrates a screen 400 which provides a summary of recent calls and timer/charge amounts. Each of the charges may be associated with details of a caller (a client) as shown at 500 in FIG. 5. Moreover, each client may have one or more matters as shown at screen 600 in FIG. 6. A user may also search by matter number as shown at screen 700 in FIG. 7.

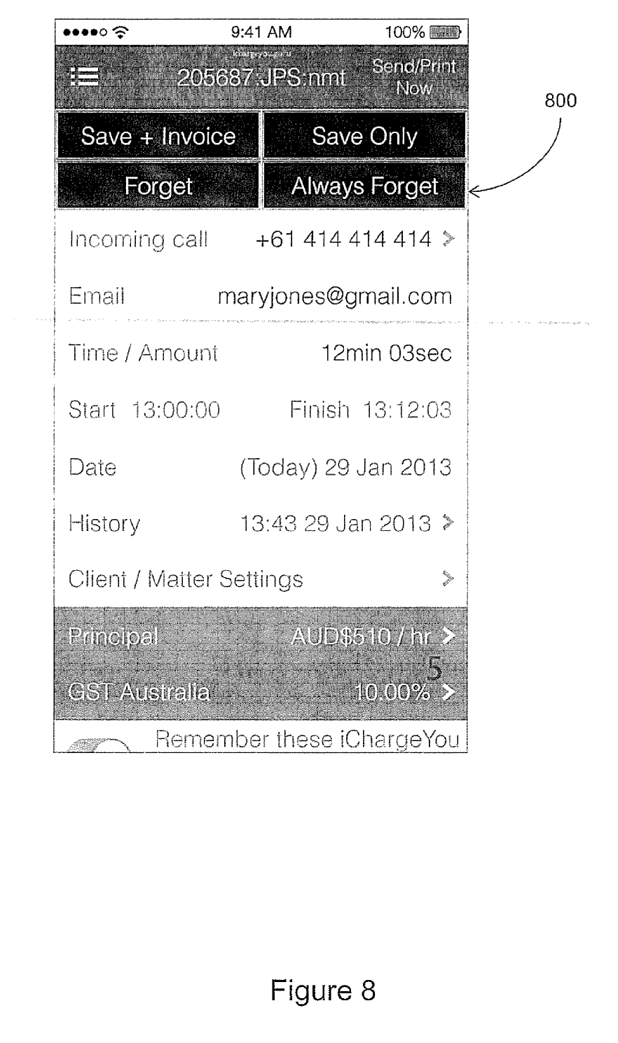

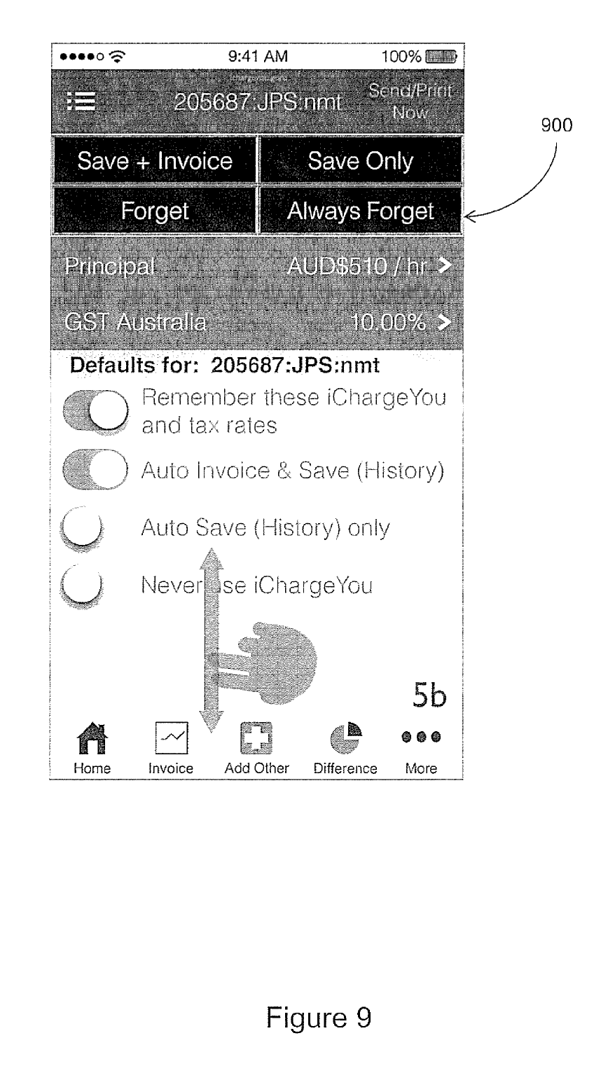

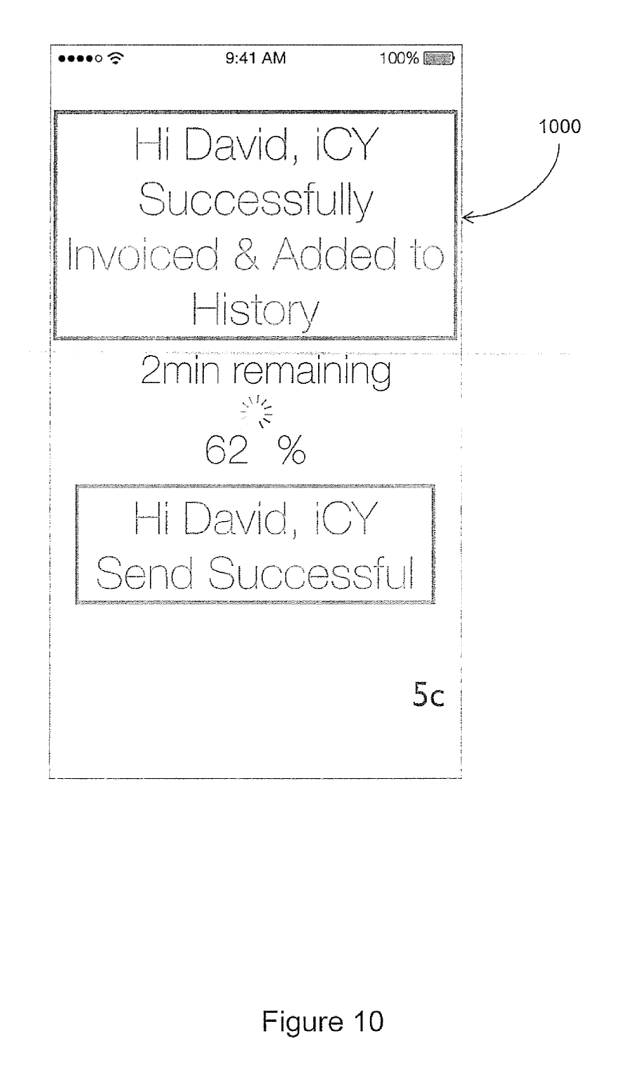

Turning to FIG. 8, at screen 800, there is shown a summary for a particular matter. The user may select certain options at 900 in FIG. 9. Invoices may be sent to clients, as per screen 1000 at FIG. 10.

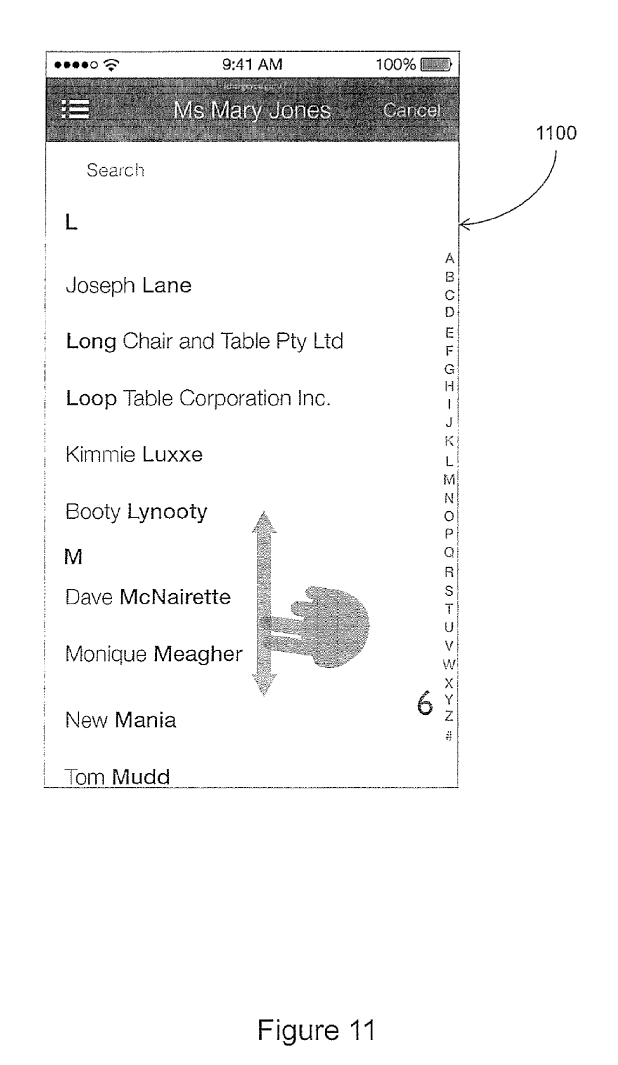

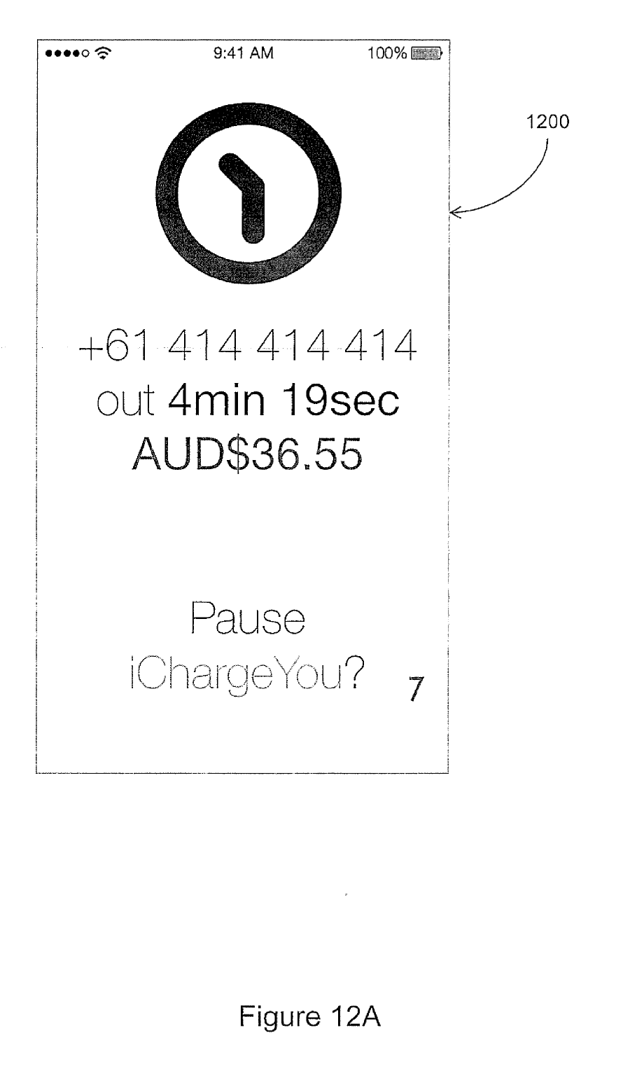

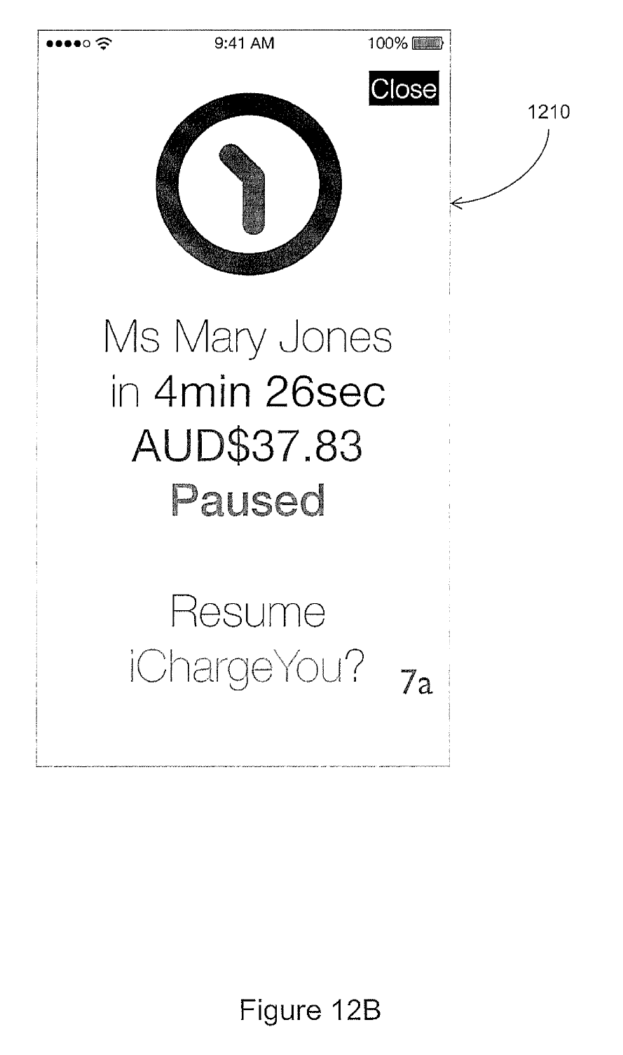

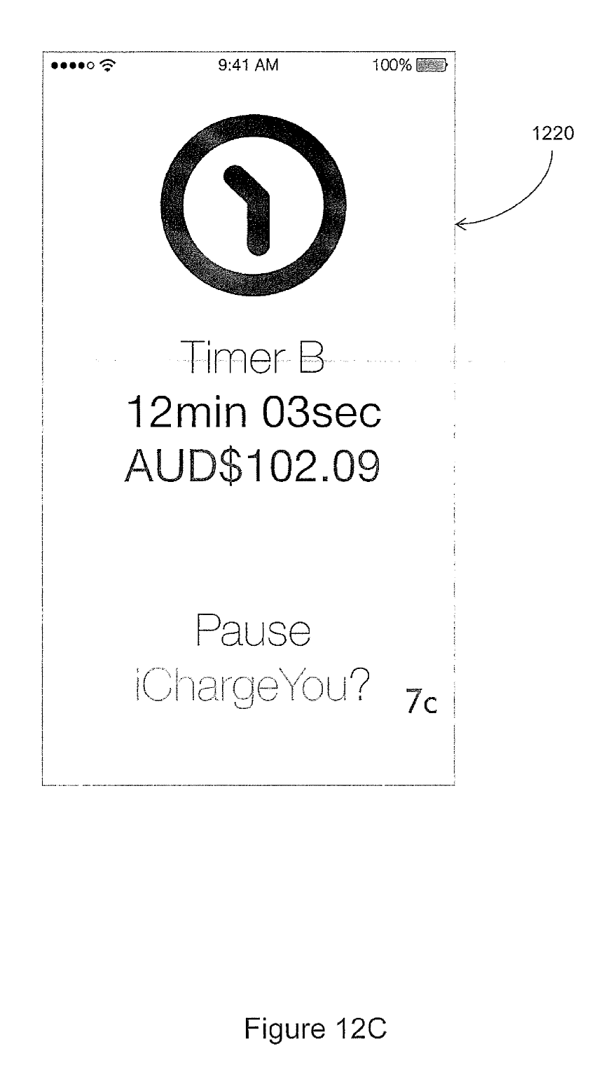

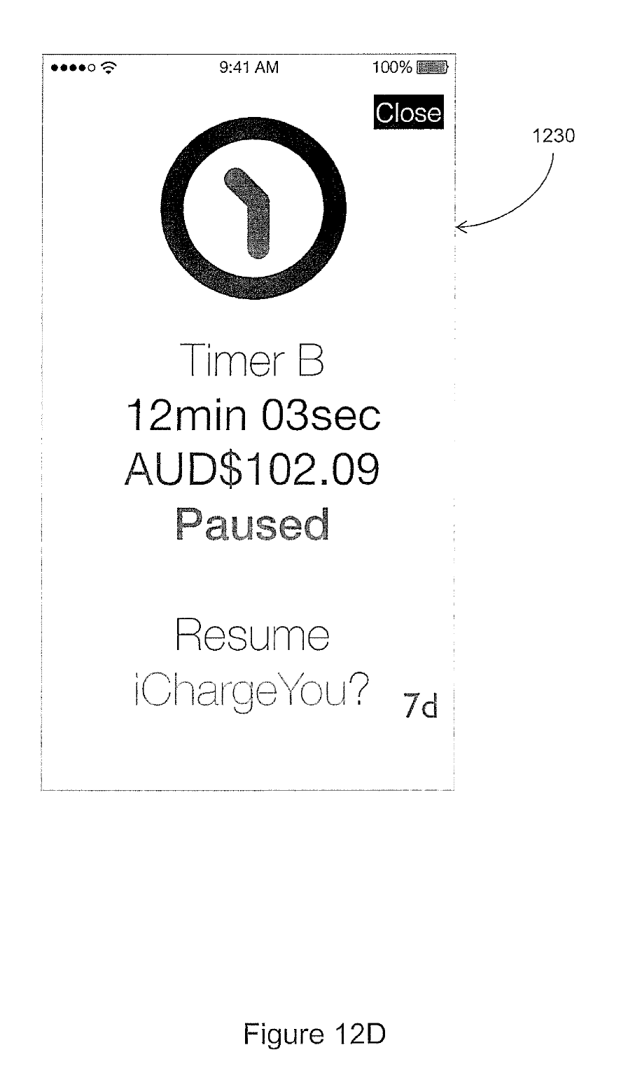

At FIG. 11, at screen 1100, there is shown a contacts list from which a client may be selected. At FIGS. 12A to 12D, at screen 1200, 1210, 1220 and 1230, there are shown successive screens of the timer in operation.

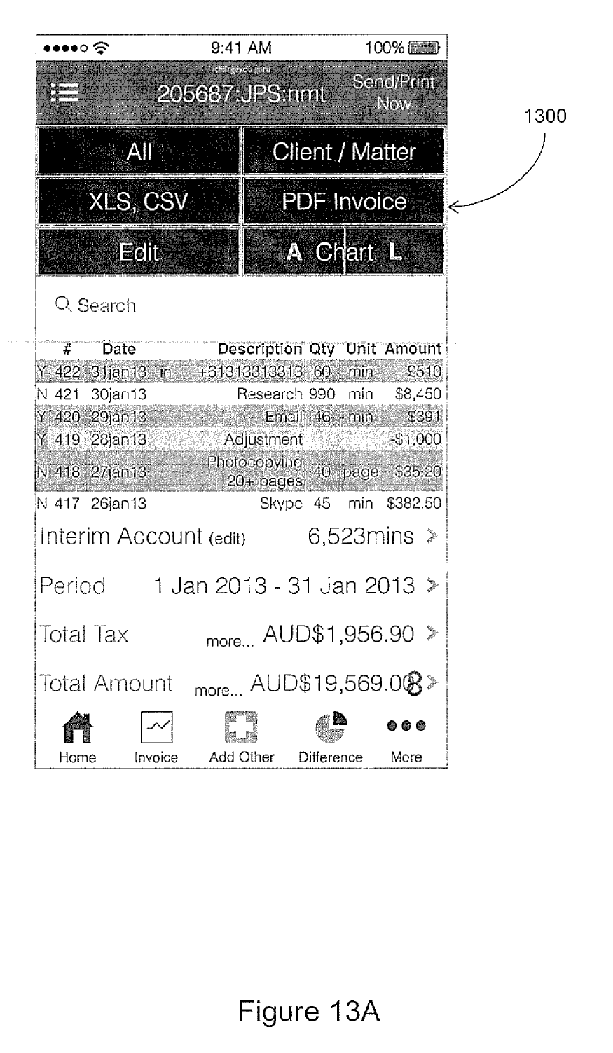

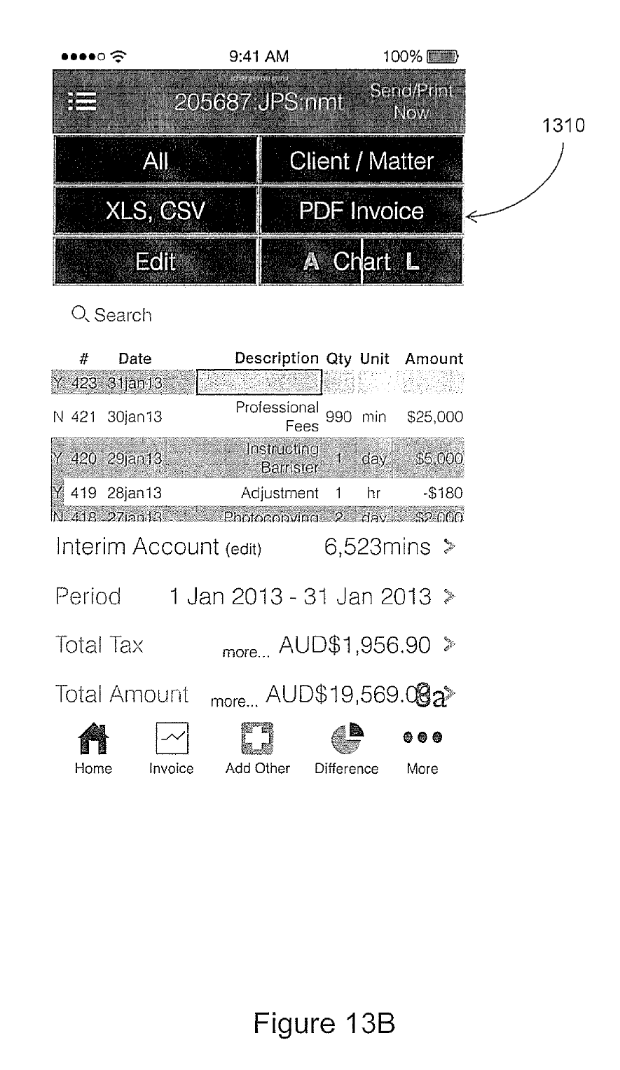

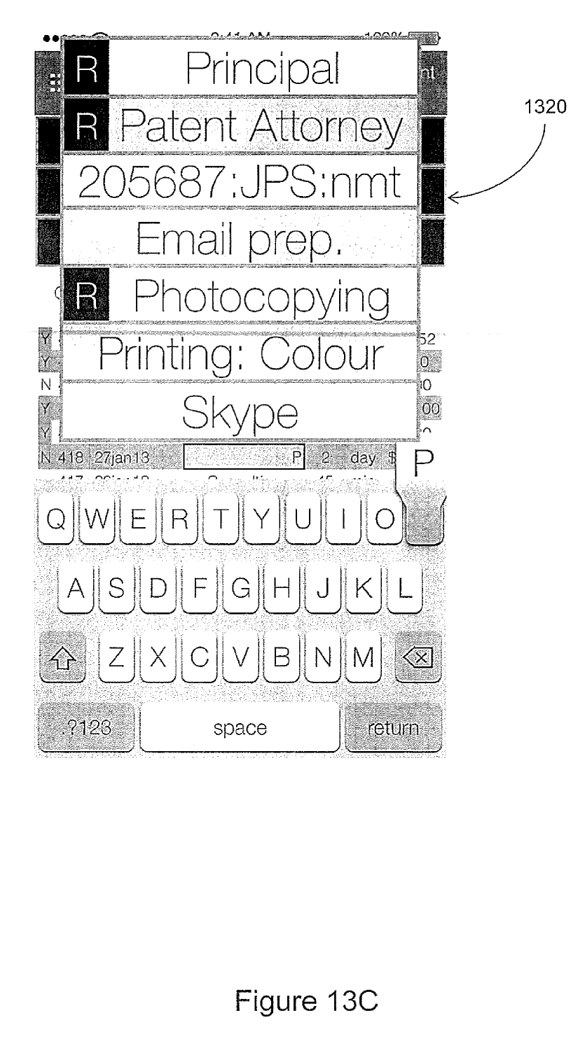

At FIGS. 13A to 13C, at screens 1300, 1310 and 1320 there is shown summary screens which lists past and present invoices and captured times for a particular client.

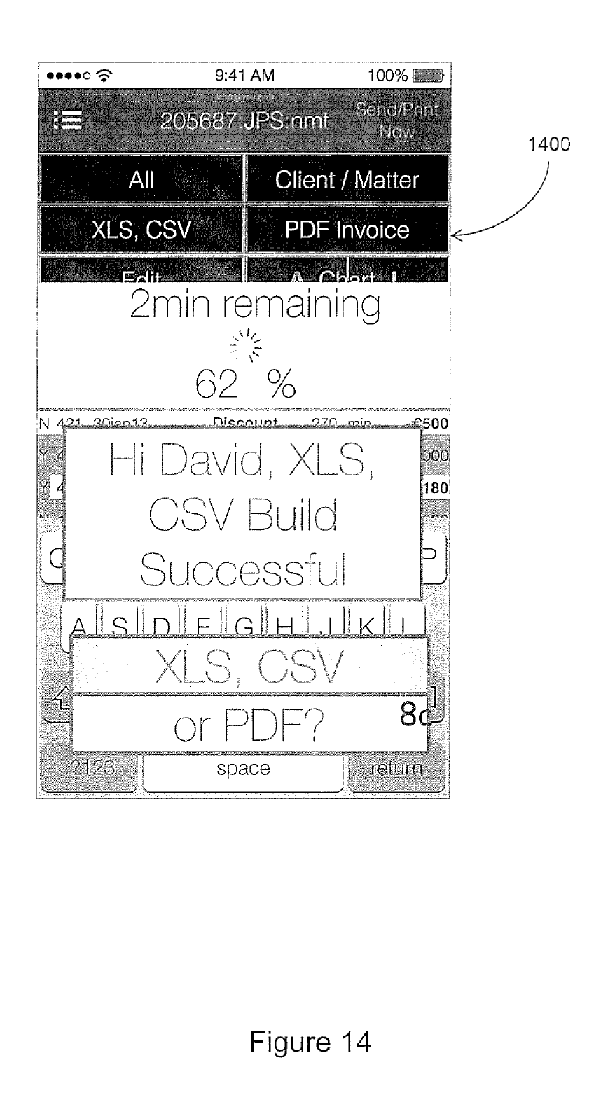

At FIG. 14, at screen 1400, there is shown an export screen (for exporting data in a different format).

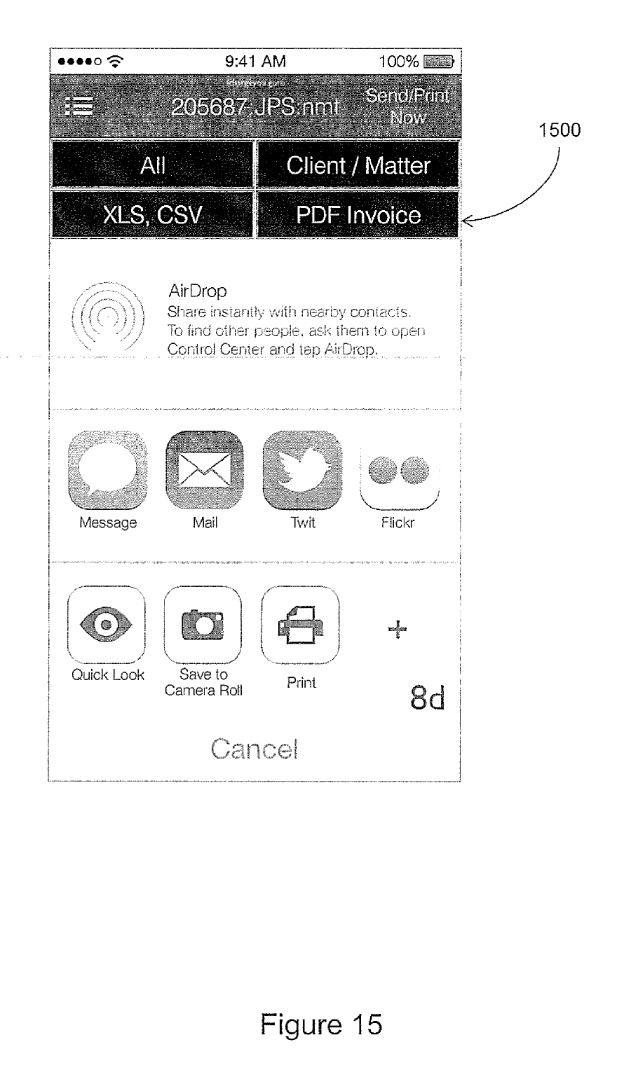

At FIG. 15, at screen 1500, there is shown a sending screen for sending invoices via a number of different channels.

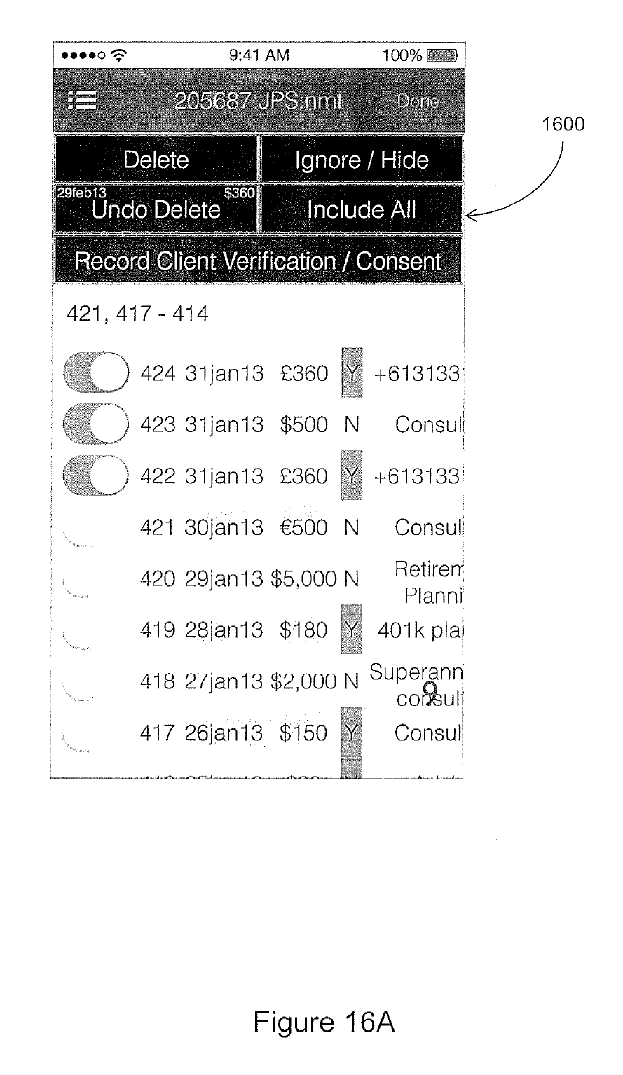

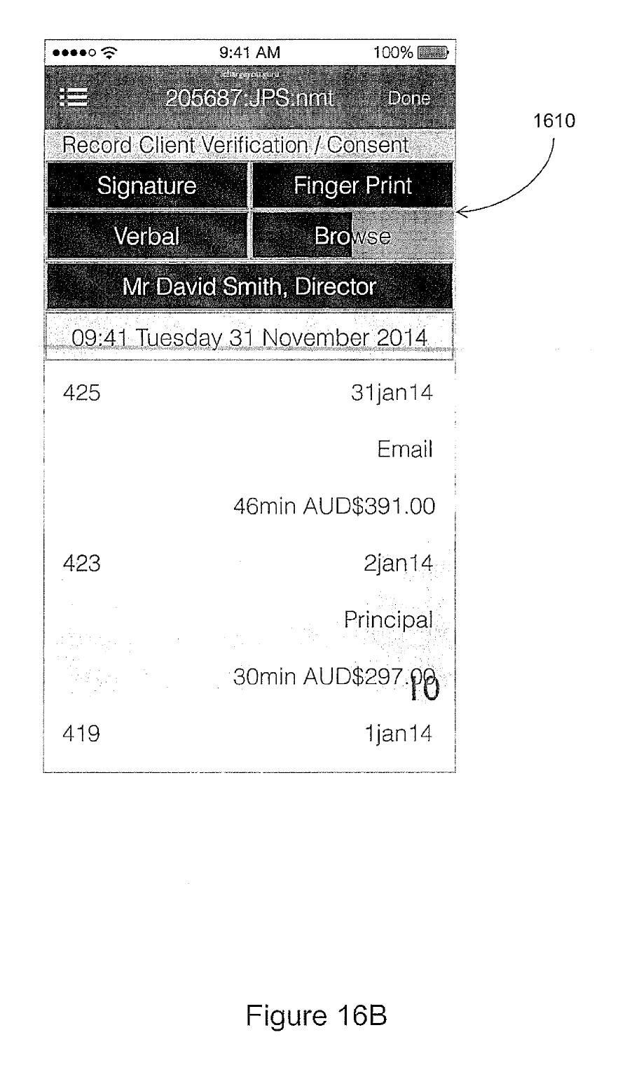

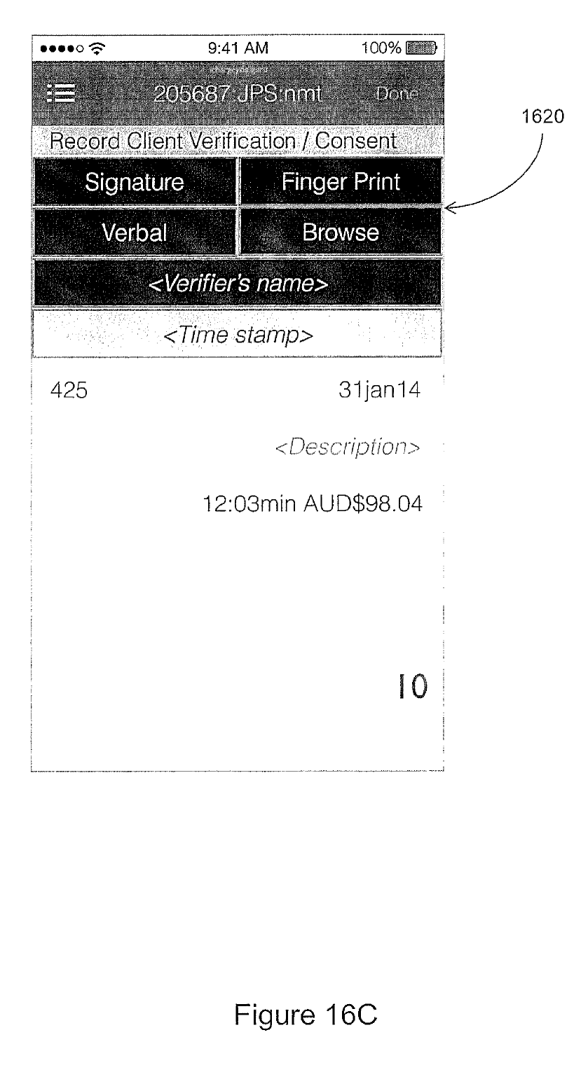

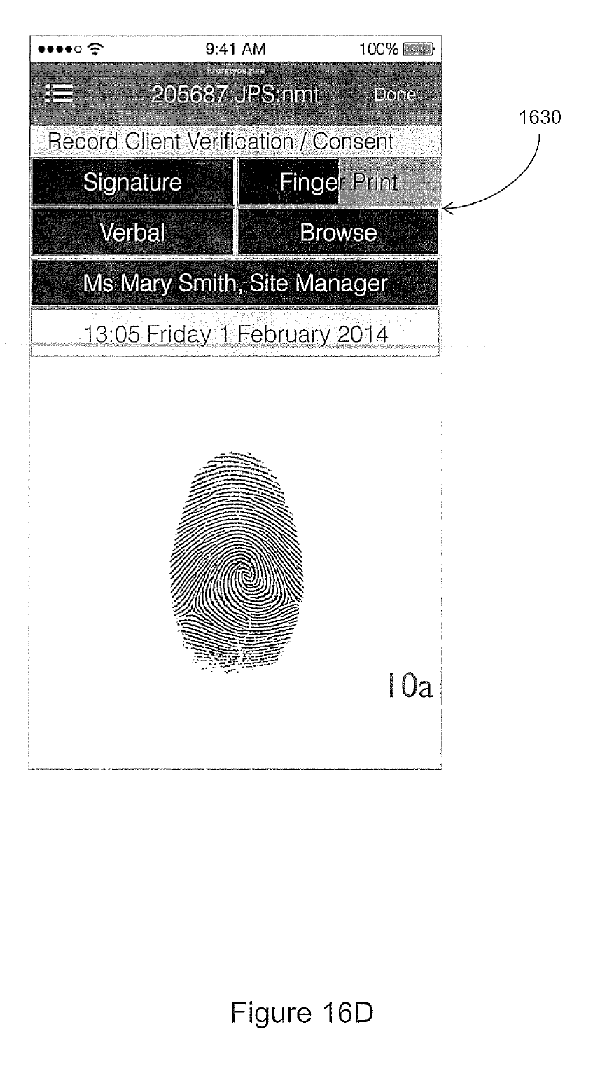

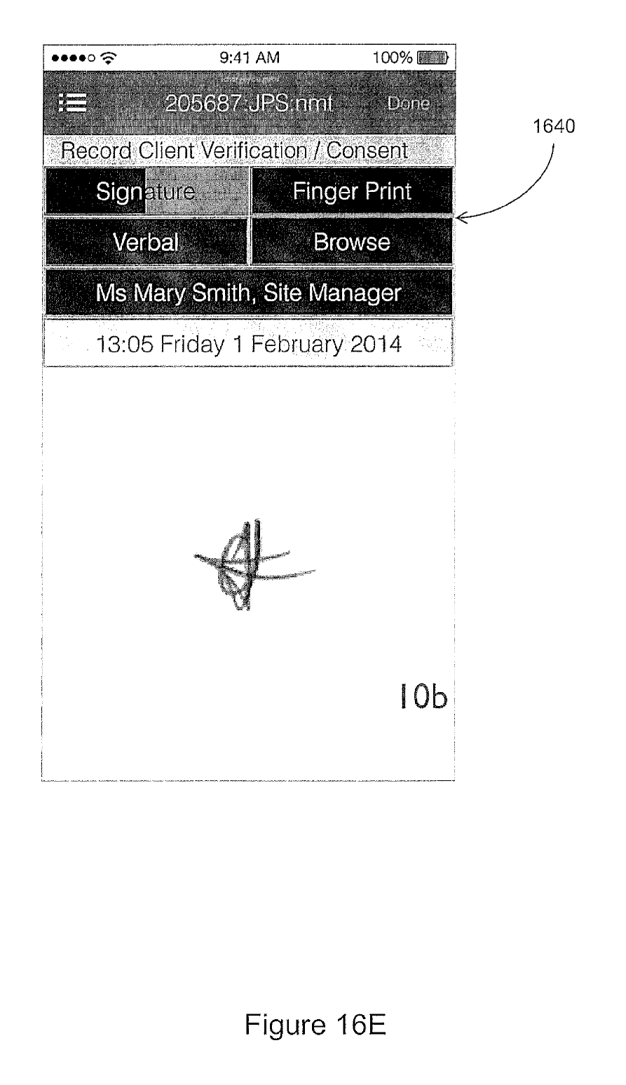

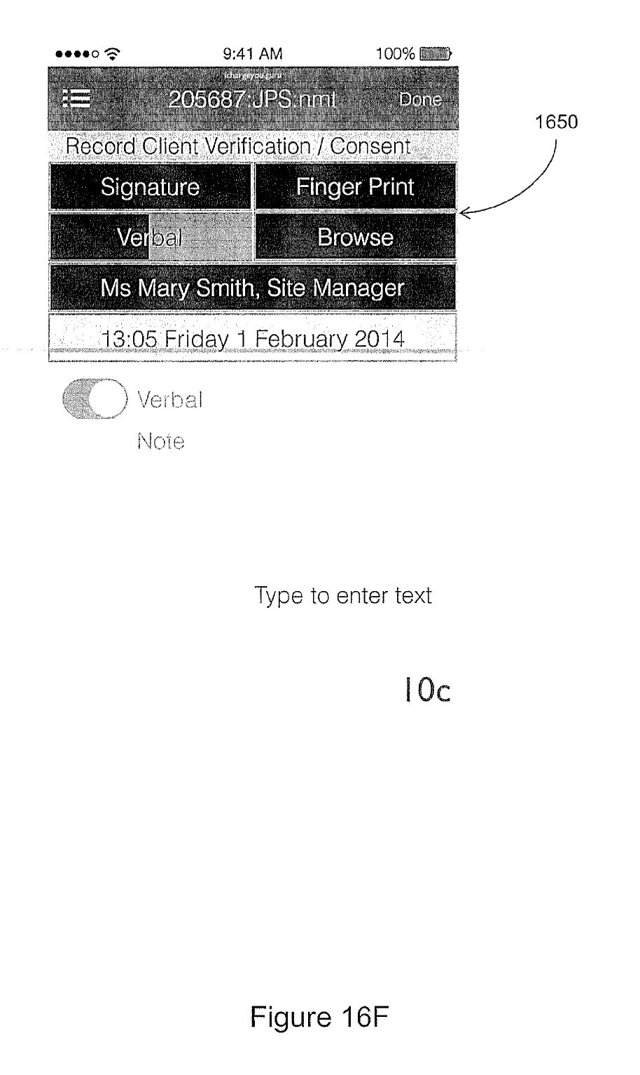

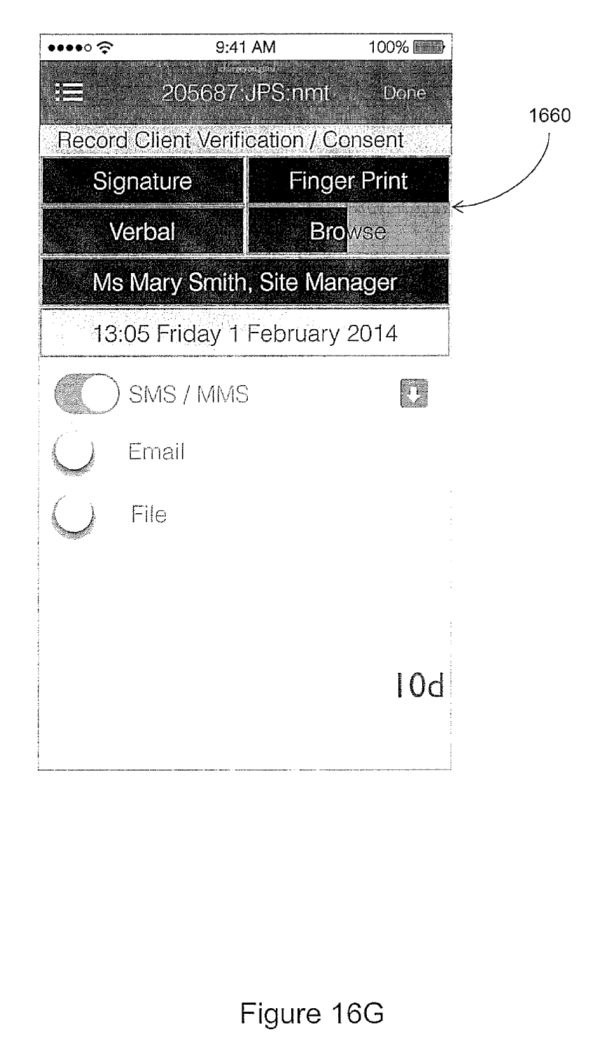

At FIGS. 16A to 16G, at screen 1600 through to 1660, there is shown various specific methods for receiving client confirmation.

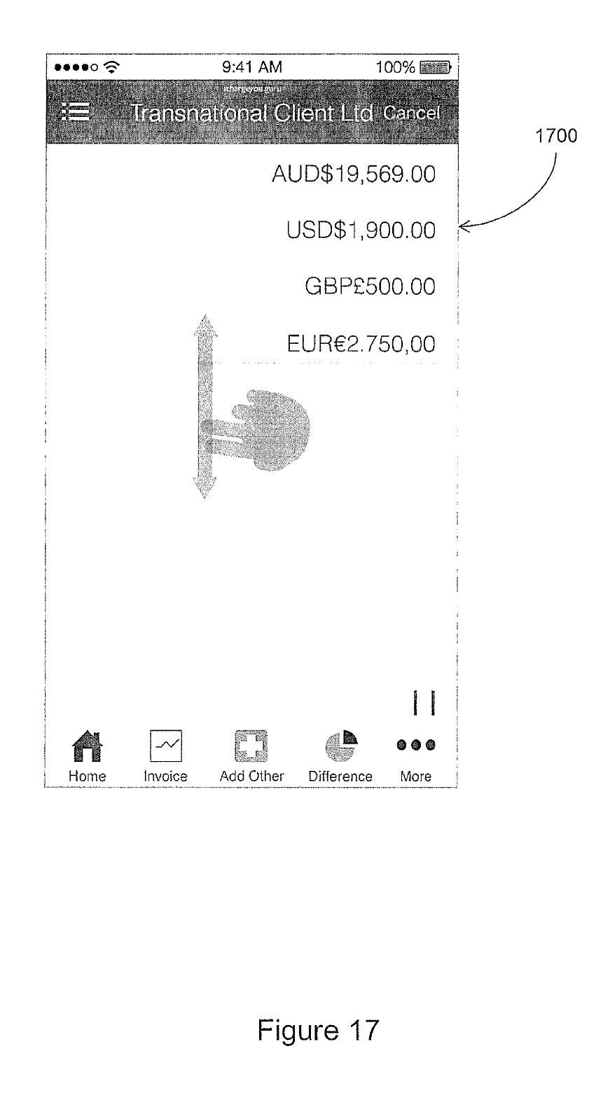

At FIG. 17, at screen 1700, there is shown a currency converter feature.

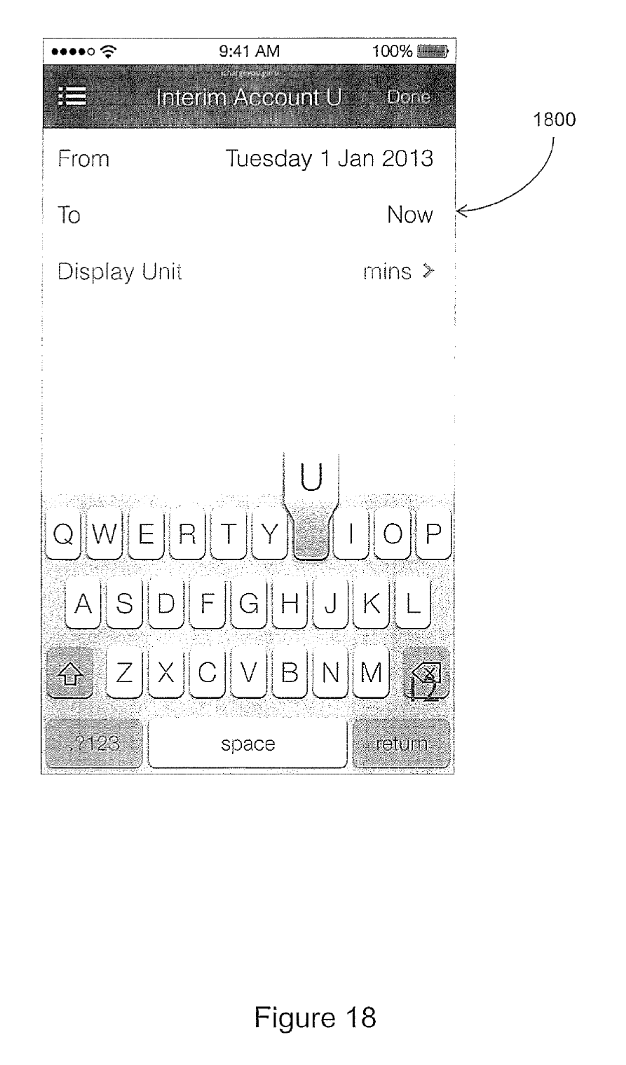

At FIG. 18, at screen 1800, there is shown a screen for setting up an interim account.

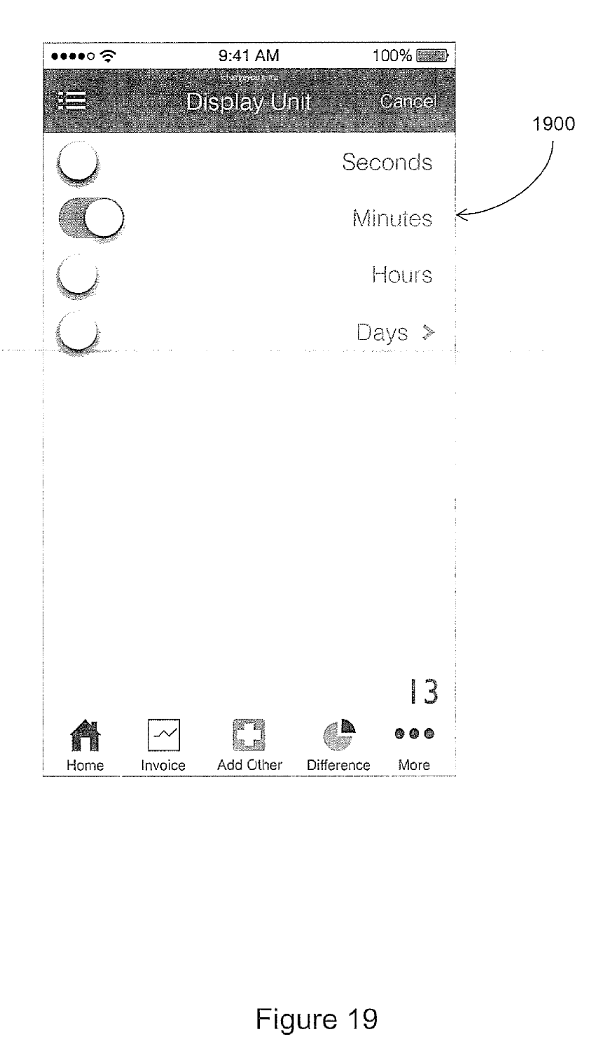

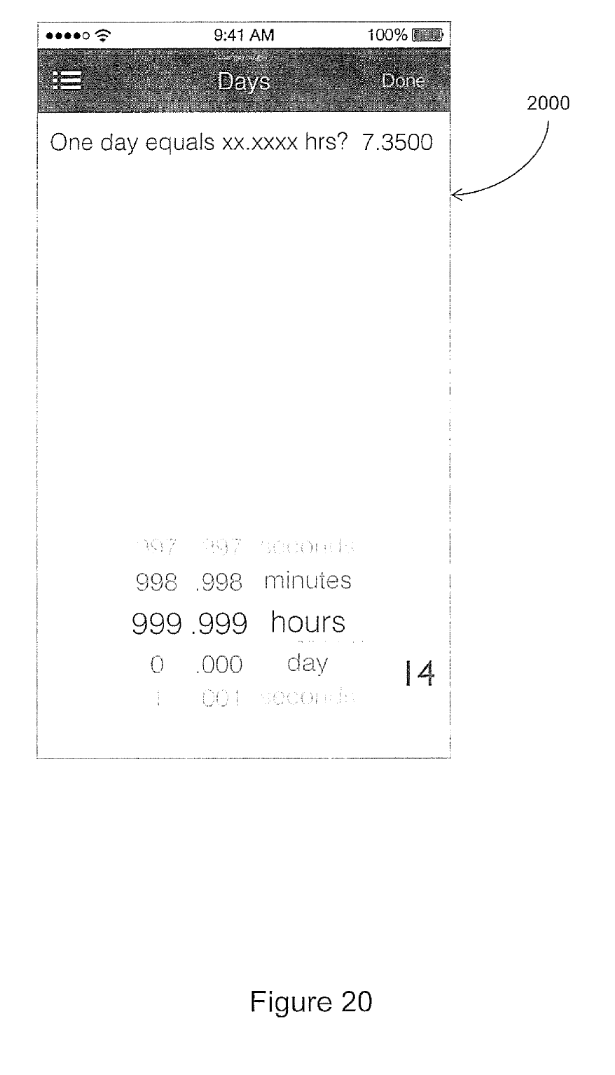

At FIG. 19, at screen 1900, there is shown a settings screen. At FIG. 20, at screen 2000, there is shown another setting screen.

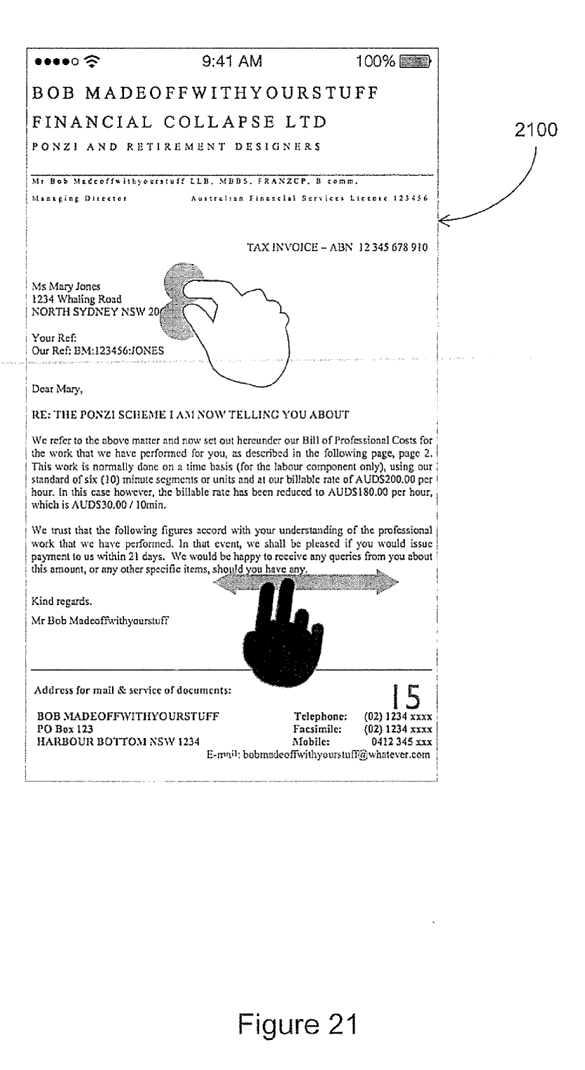

At FIG. 21, at screen 2100, there is shown a standard letter template screen.

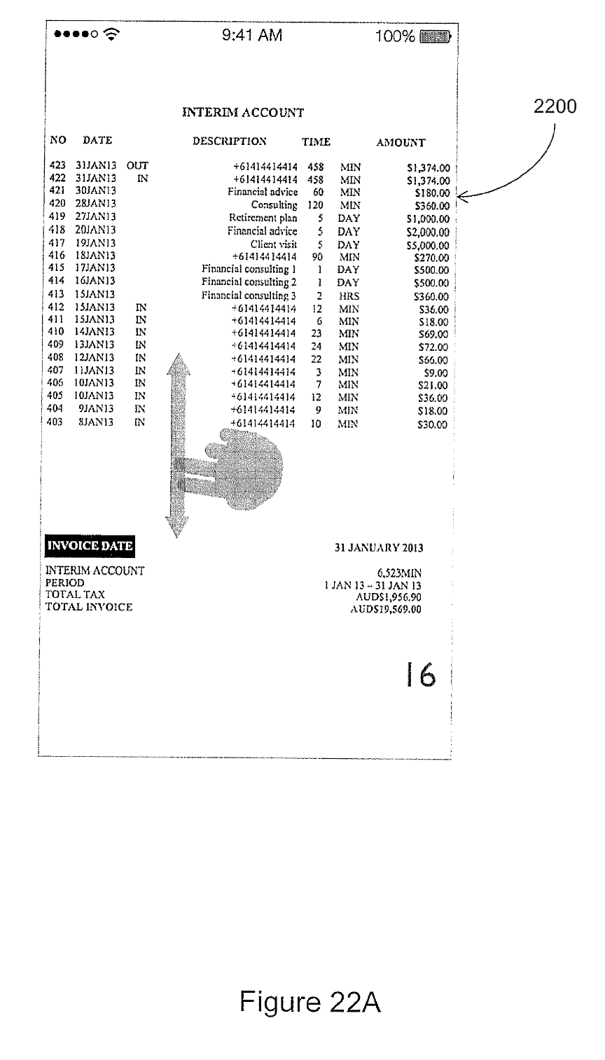

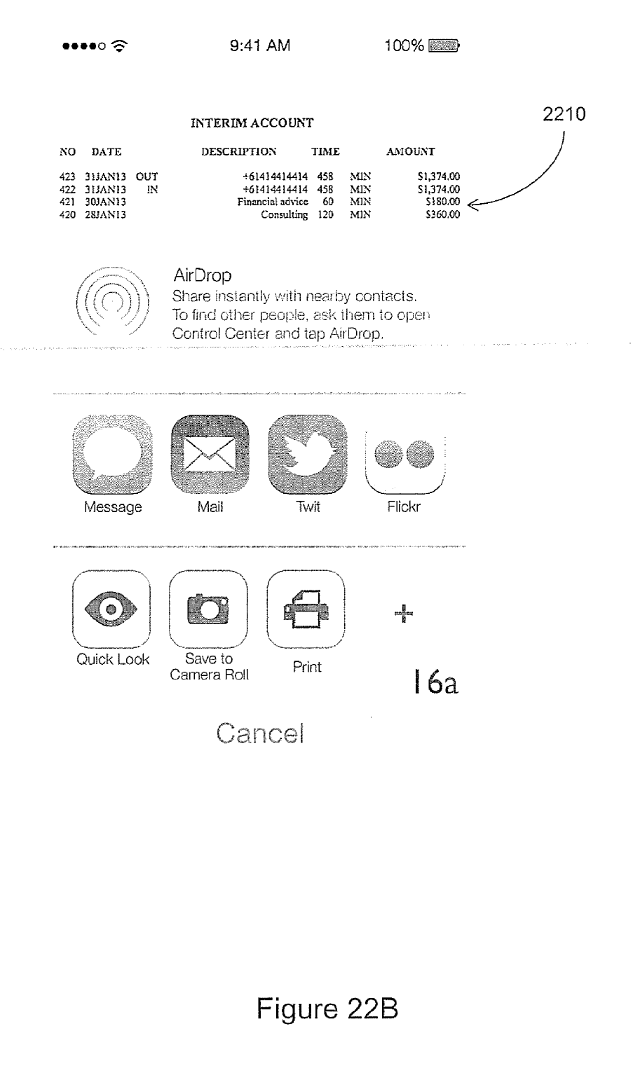

At FIGS. 22A and 22B, at screens 2200 and 2210, there are shown generated statement screens.

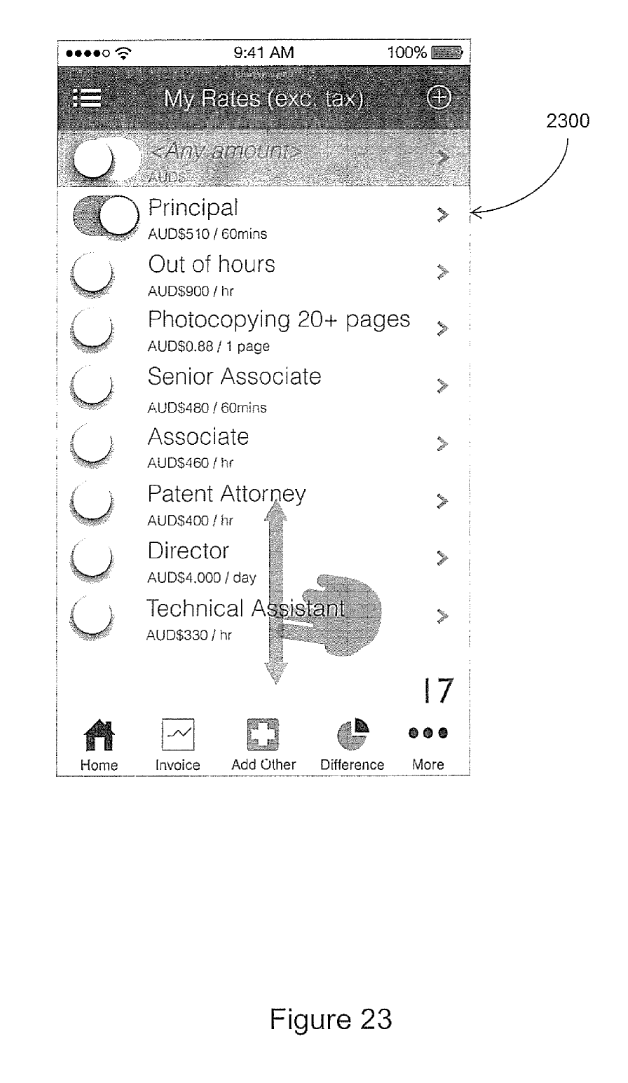

At FIG. 23, at screen 2300, there is shown another setting screen.

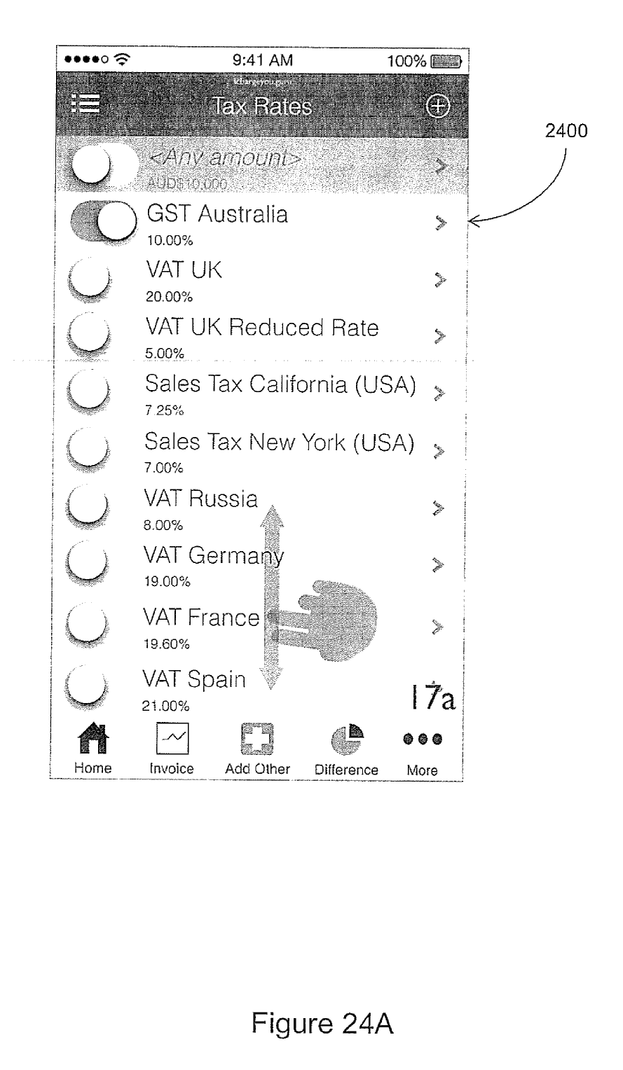

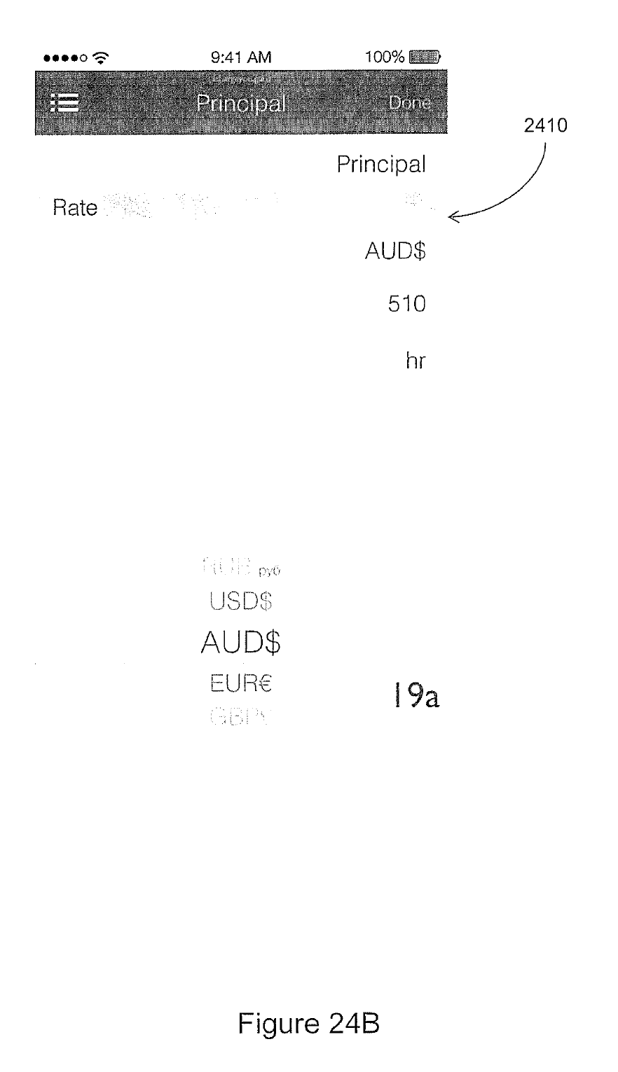

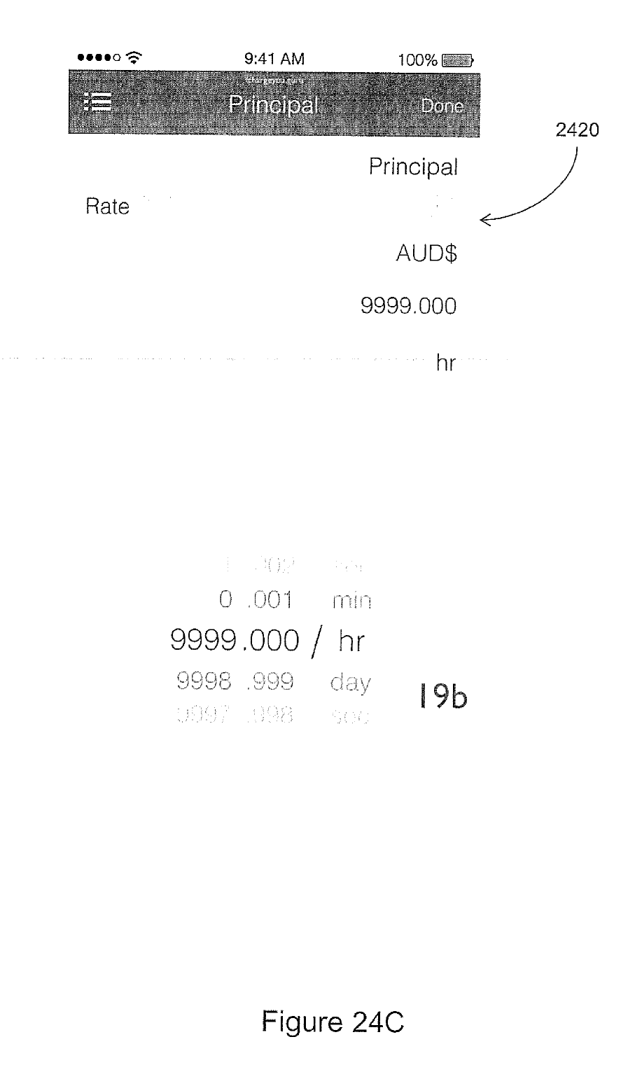

At FIGS. 24A, 24B and 24C, at screen 2400, 2410 and 2420 there is shown yet other settings screens.

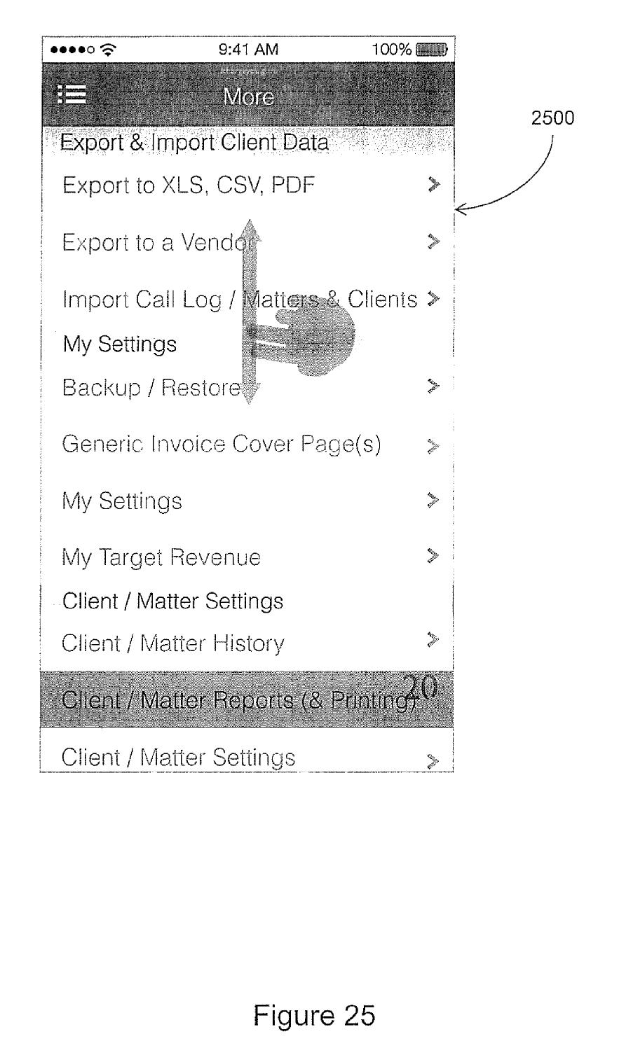

At FIG. 25, at screen 2500, there is shown another settings screen.

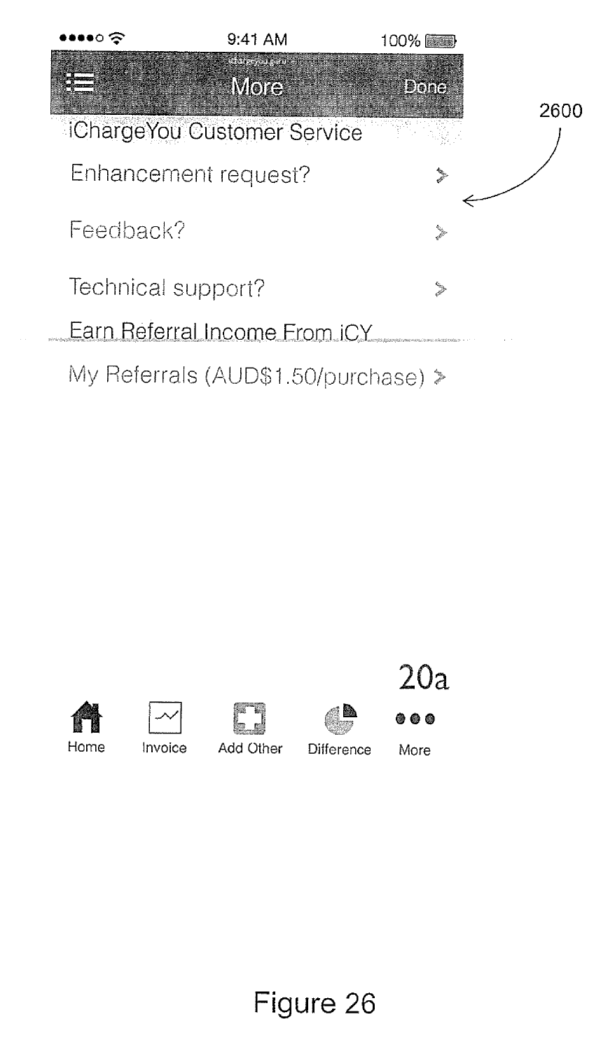

At FIG. 26, at screen 2600, there is shown a referral screen.

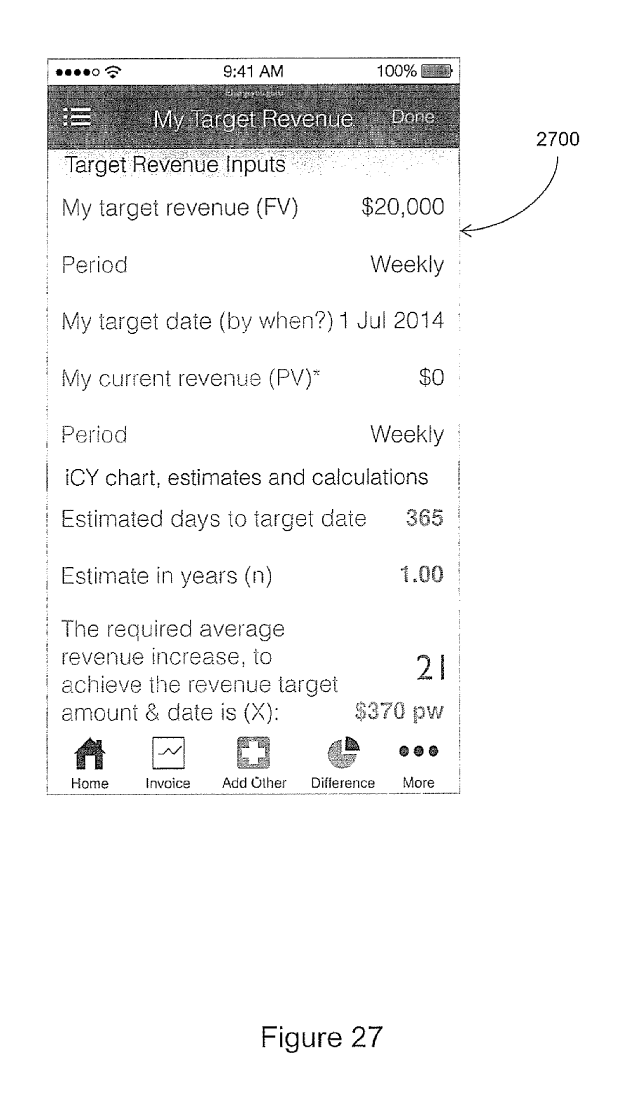

At FIG. 27, at screen 2700, there is shown a statistics screen.

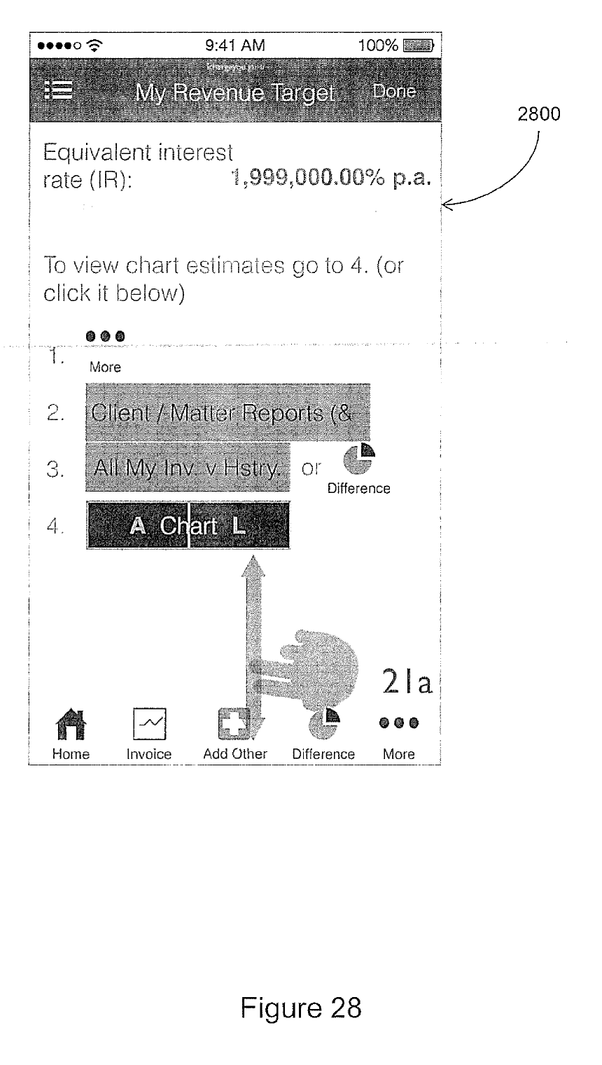

At FIG. 28, at screen 2800, there is shown another statistics screen.

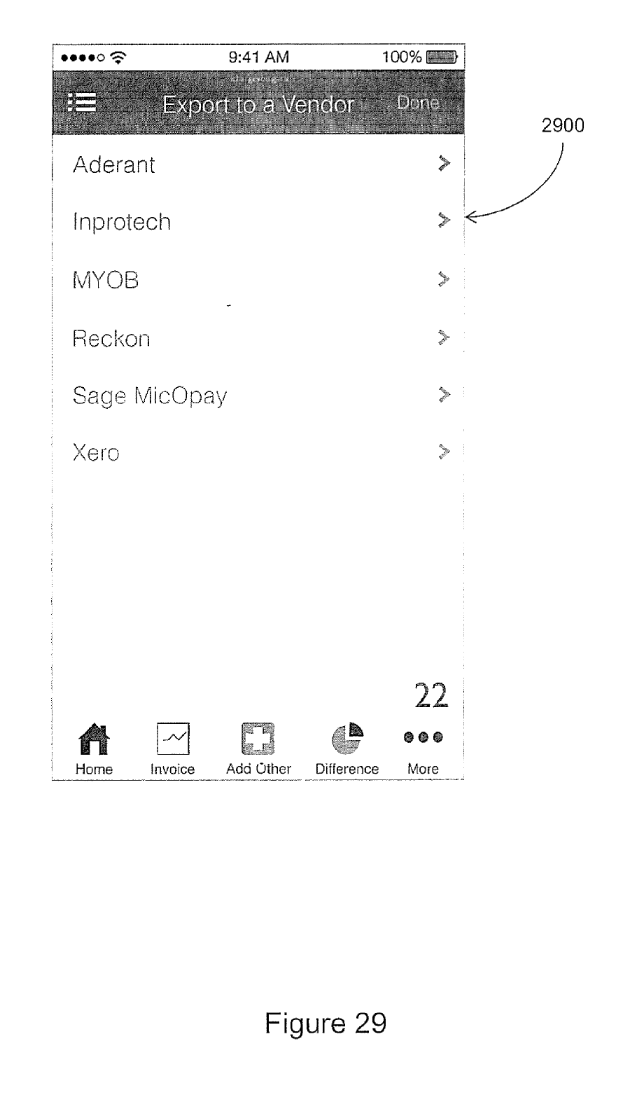

At FIG. 29, at screen 2900, there is shown another export screen.

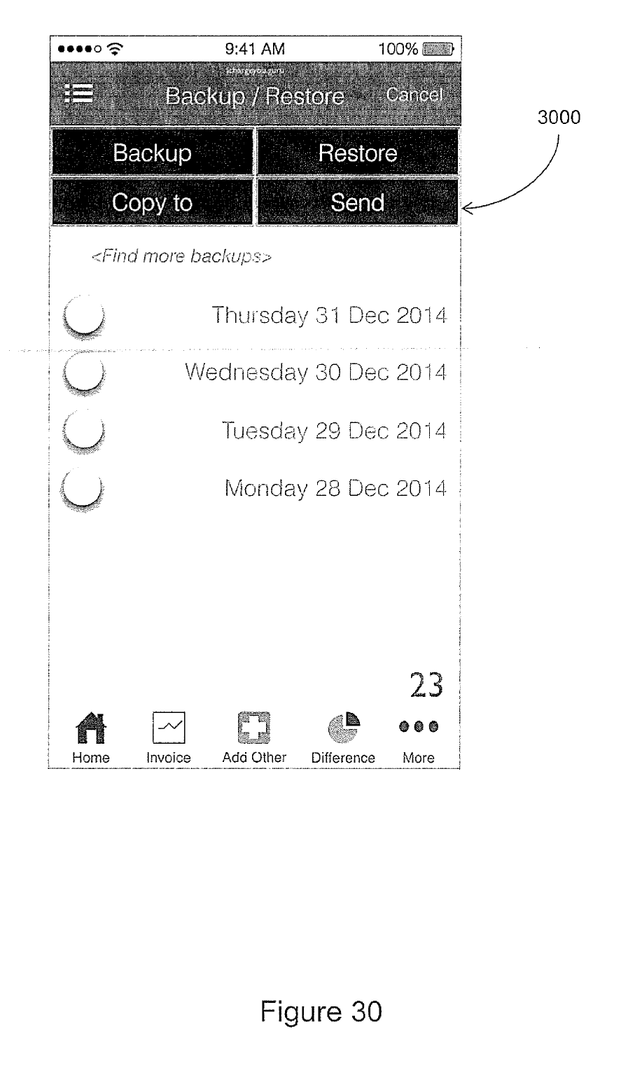

At FIG. 30, at screen 3000, there is shown a backup/restore screen.

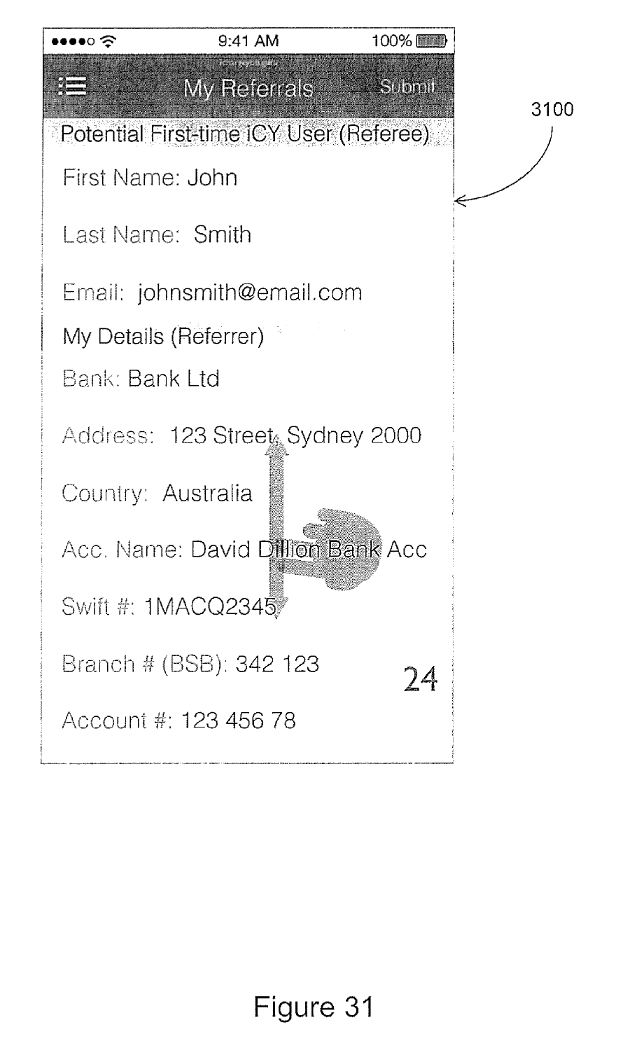

At FIG. 31, at screen 3100, there is shown another referral screen.

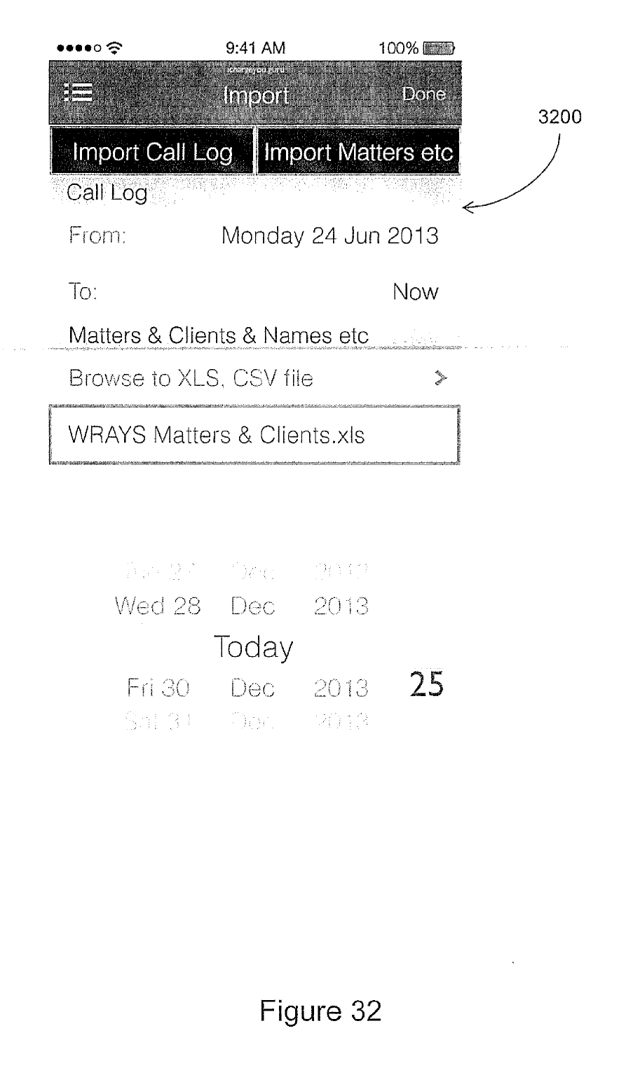

At FIG. 32, at screen 3200, there is shown an import data screen.

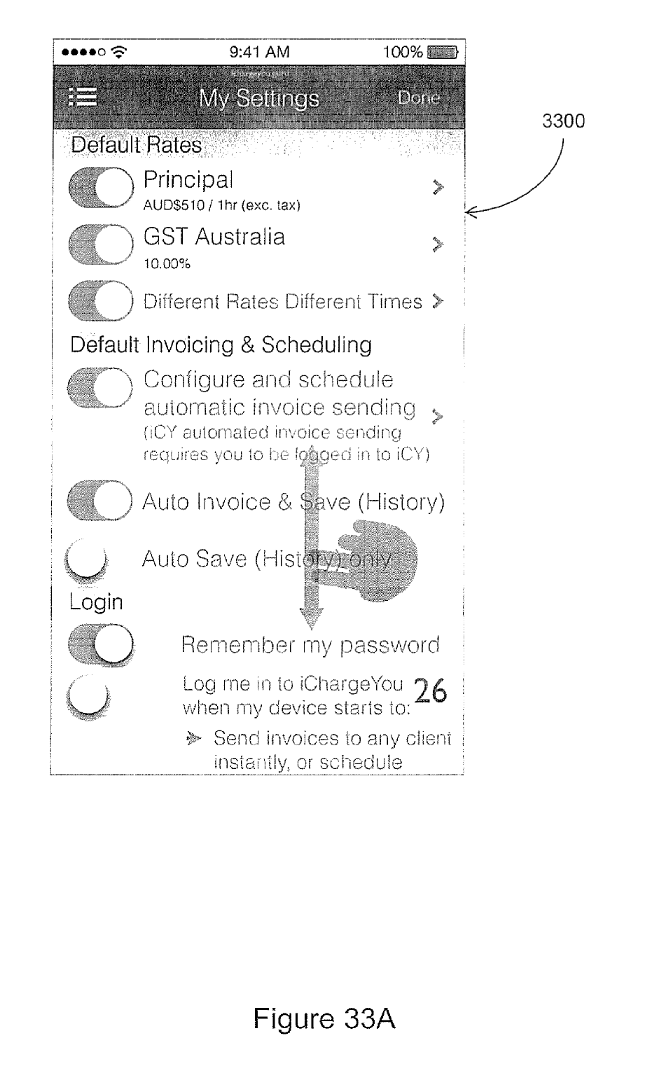

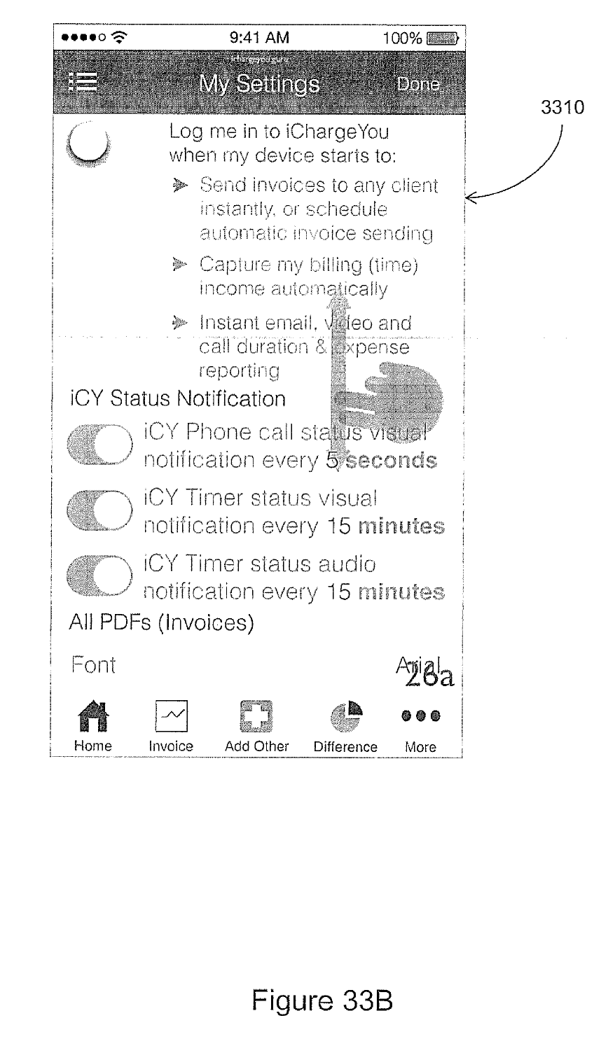

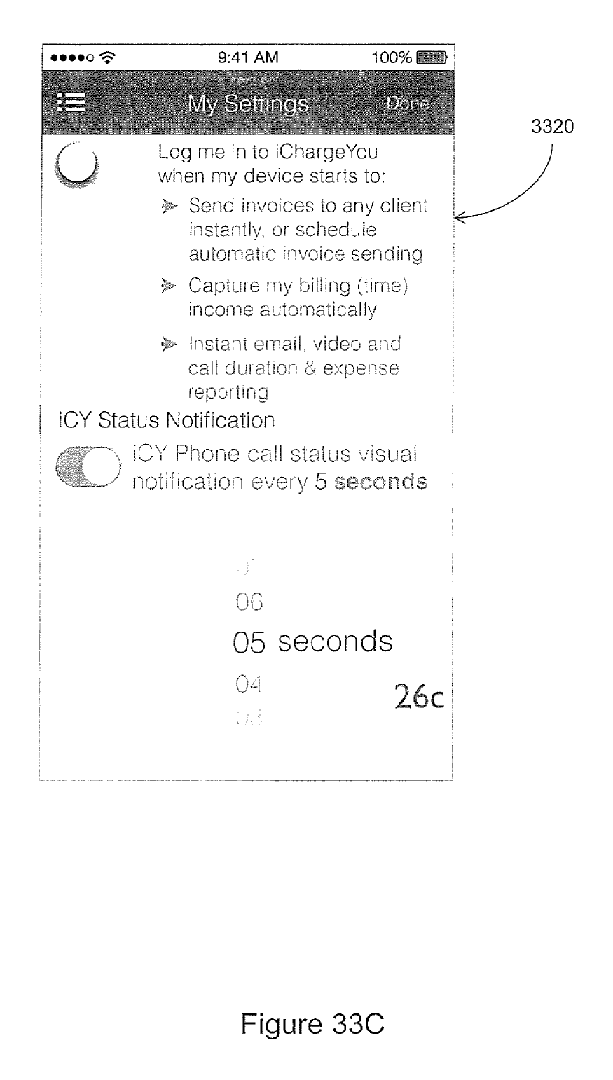

At FIGS. 33A to 33C, at screens 3300 to 3330, there are shown various settings screens.

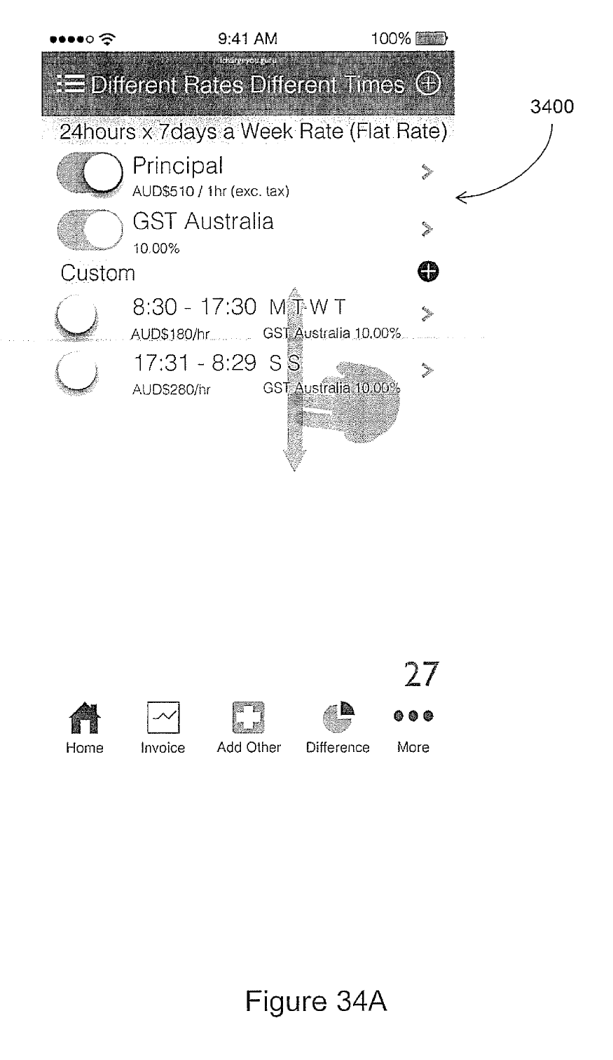

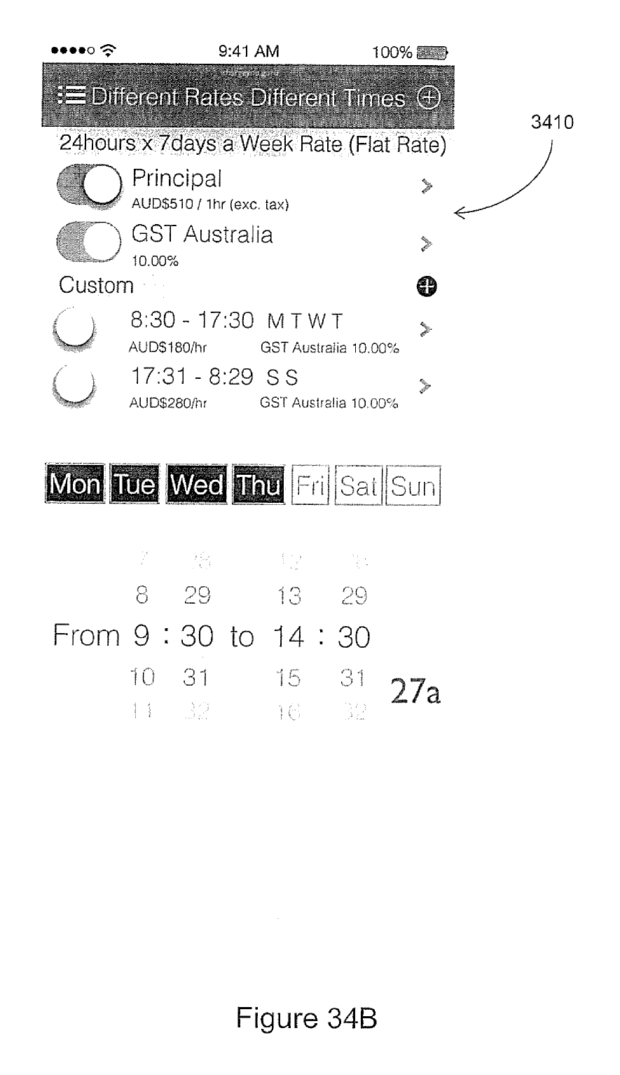

At FIGS. 34A to 34B at screens 3400 to 3410, there are shown various settings screens, for different rates at different times and days of the week.

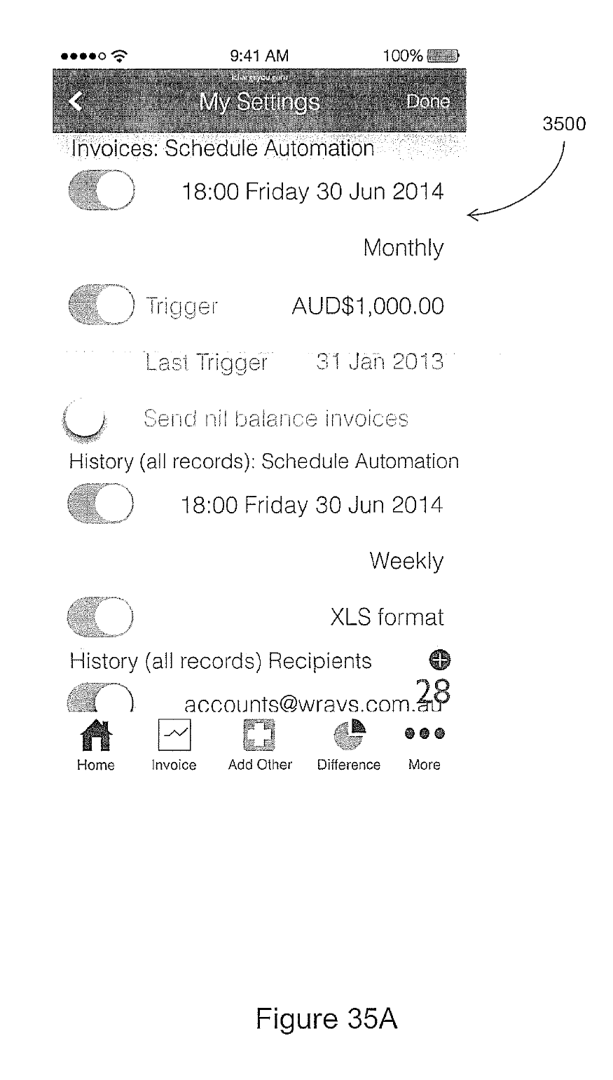

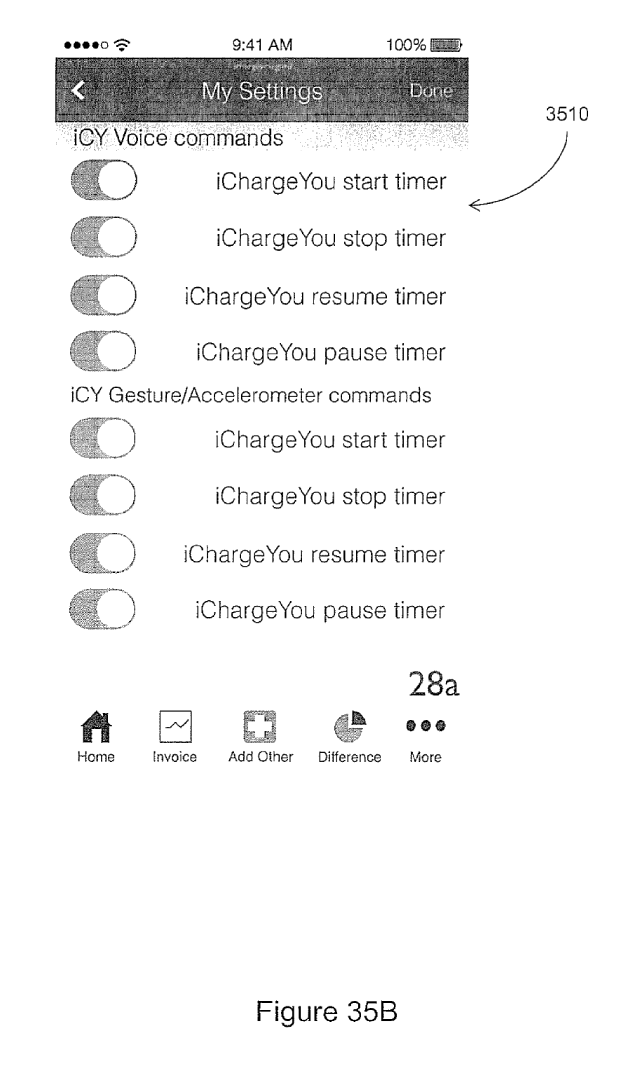

At FIGS. 35A to 35B at screens 3500 to 3510, there are shown various settings screens, showing calendar settings for the automated scheduled sending, of invoices and client history, and the settings for recording and storing voice command and gesture/accelerometer command settings screens.

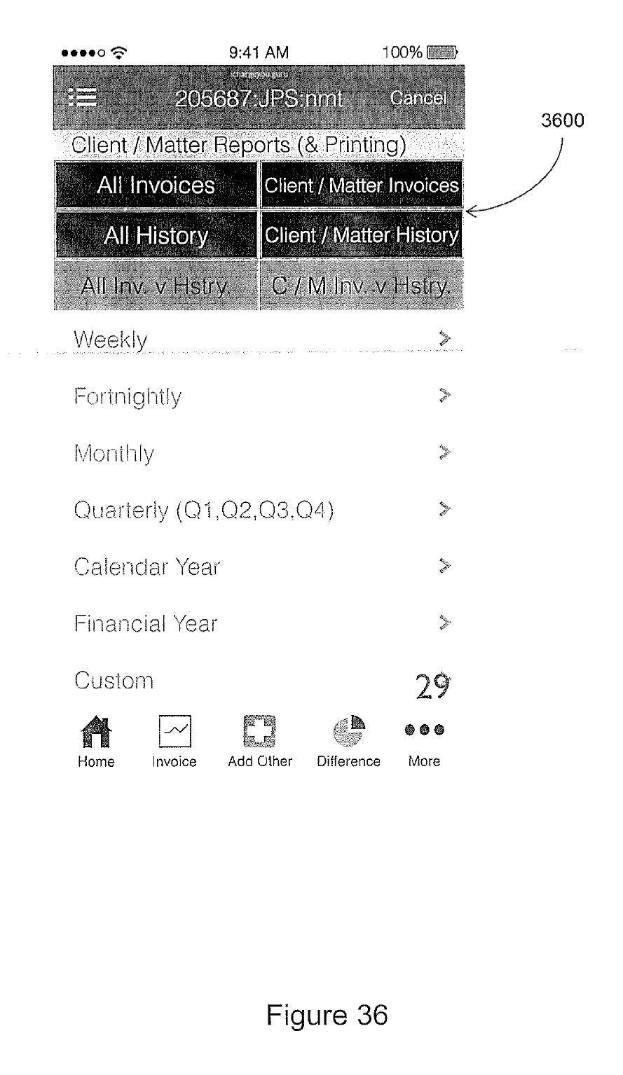

At FIG. 36 at screen 3600, there are shown various settings screens, showing client and matter data reporting options for different periods of invoices and history settings screen.

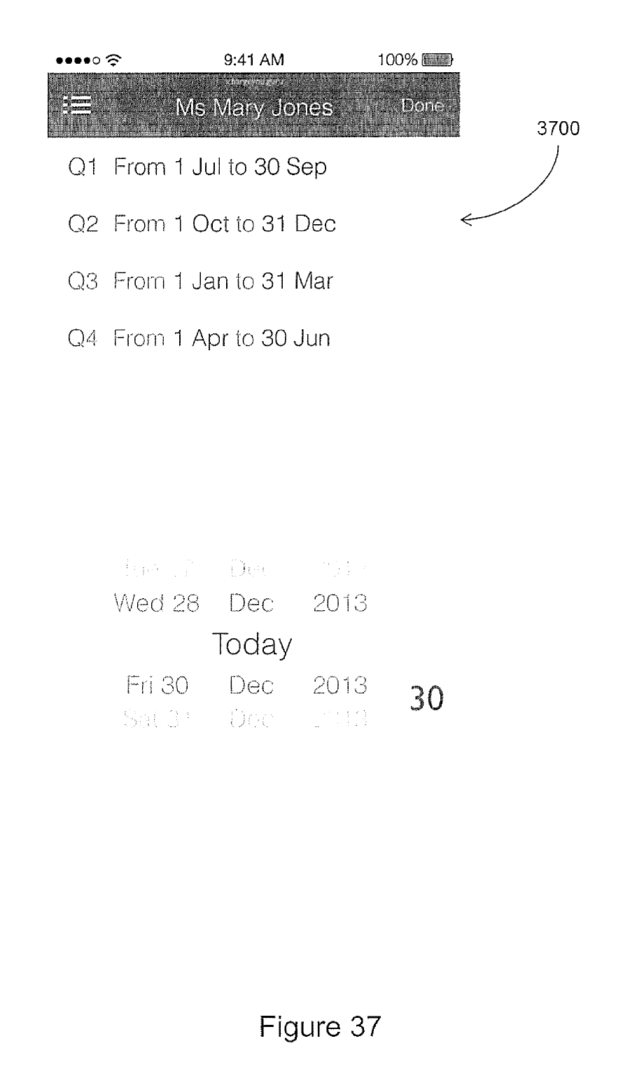

At FIG. 37 at screen 3700 there are shown various settings screens, showing client and matter data reporting for specified time periods setting screen.

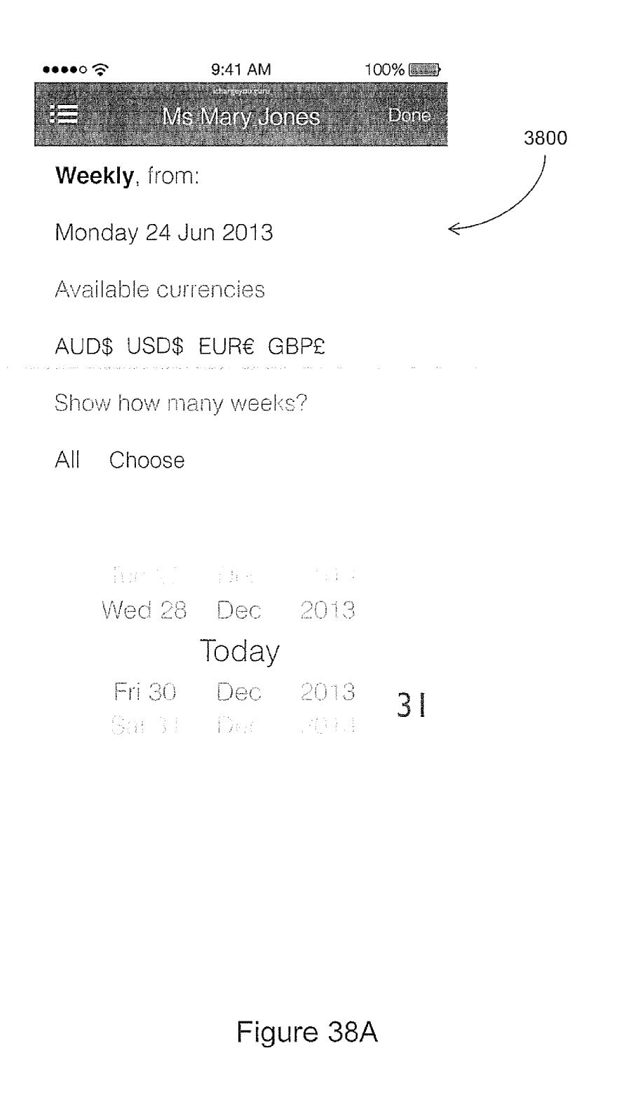

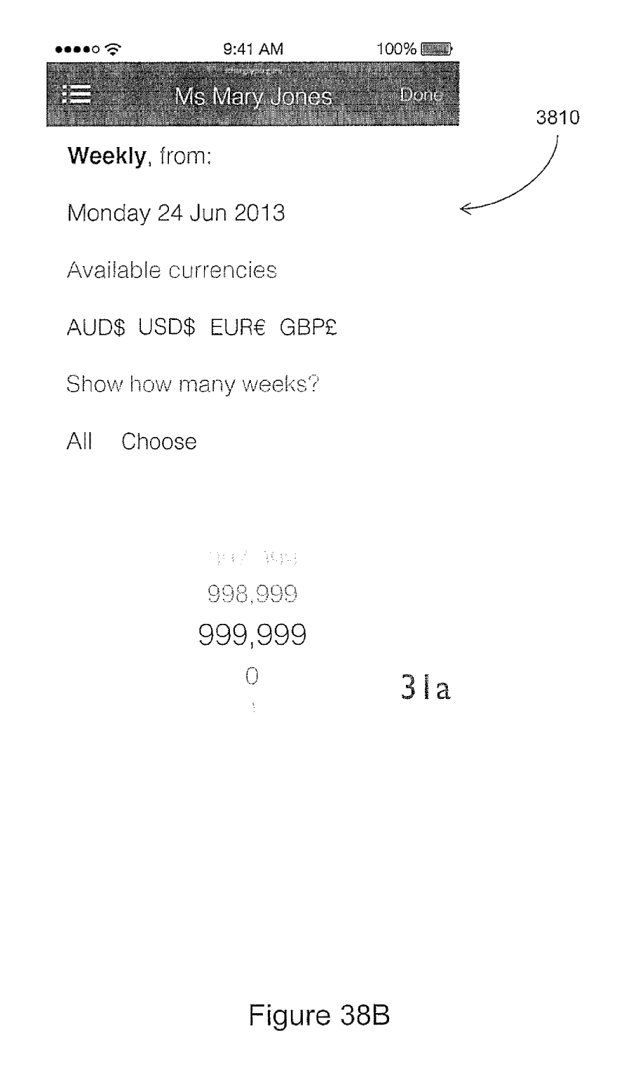

At FIGS. 38A and 38B at screens 3800 and 3810, there are shown various settings screens, showing client and matter data reporting for specified time periods setting screen.

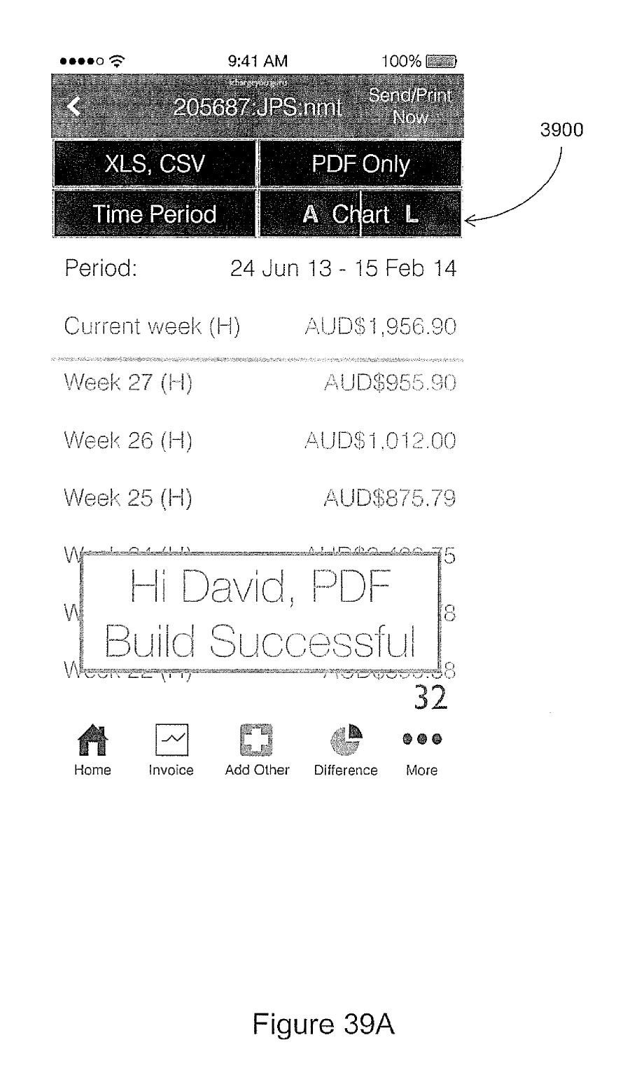

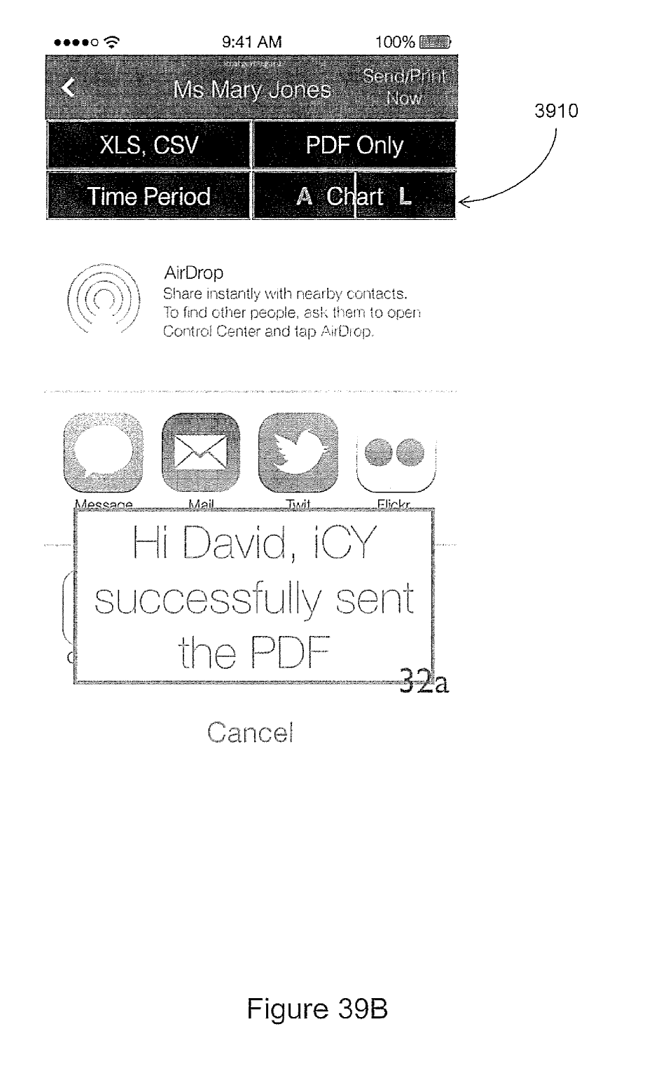

At FIGS. 39A and 39B at screens 3900 and 3910, there are shown various settings screens, showing the specified period of data settings screens.

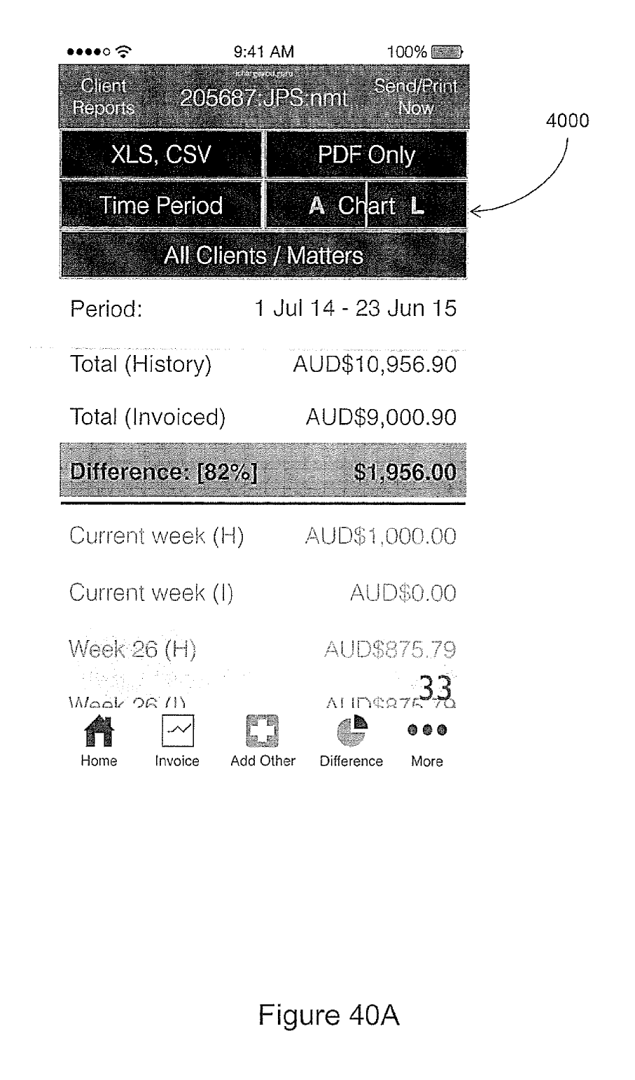

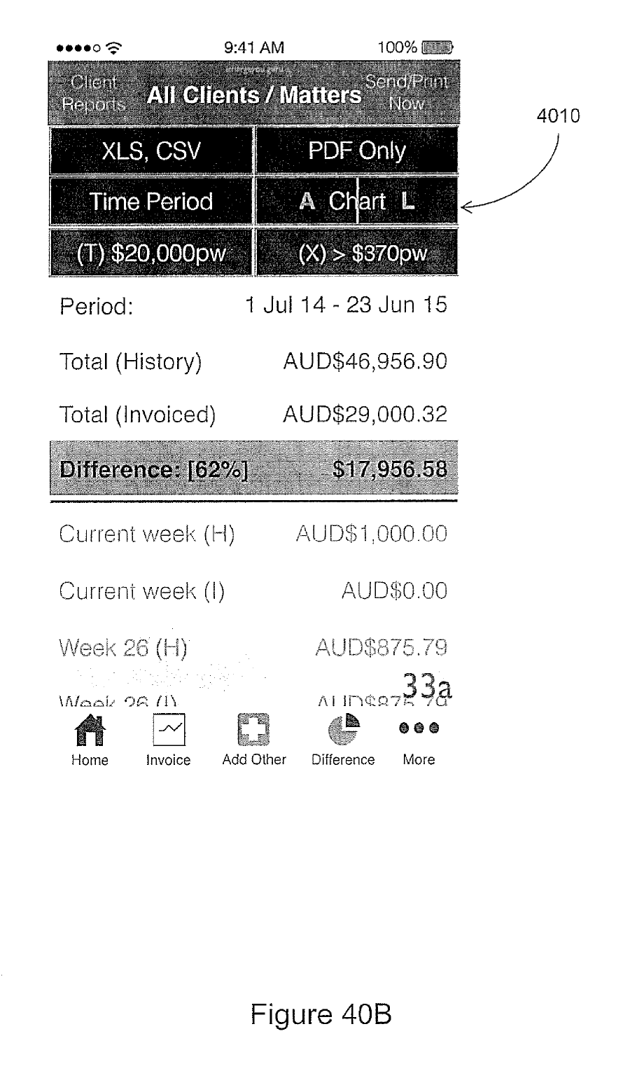

At FIGS. 40A and 40B at screens 4000 and 4010, there are shown various settings screens, showing the specified period of data comparing which amounts have been invoiced, to those which have not been invoiced settings screens.

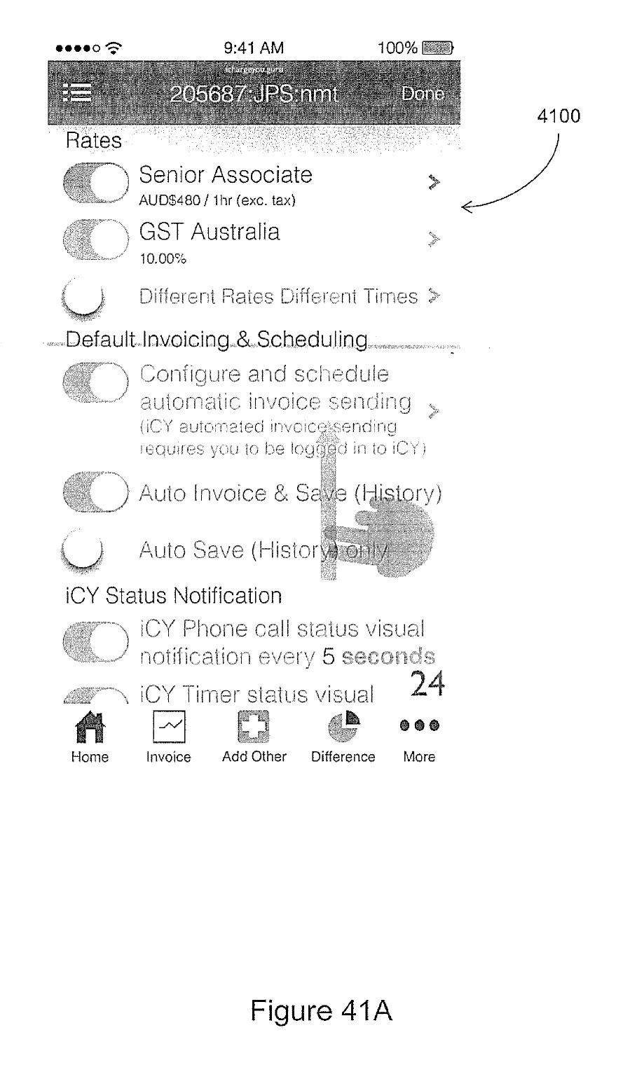

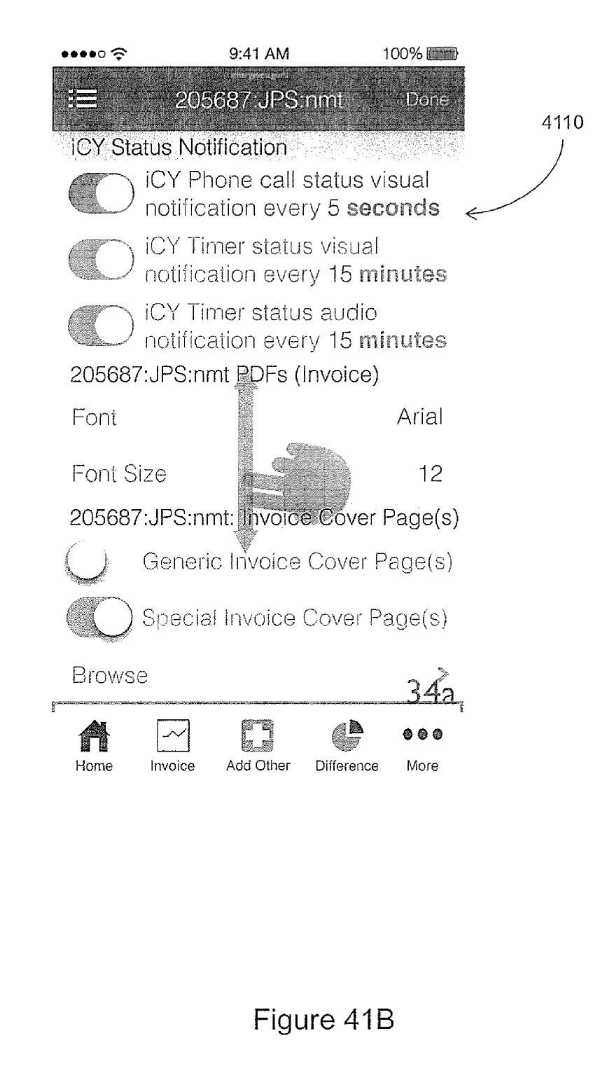

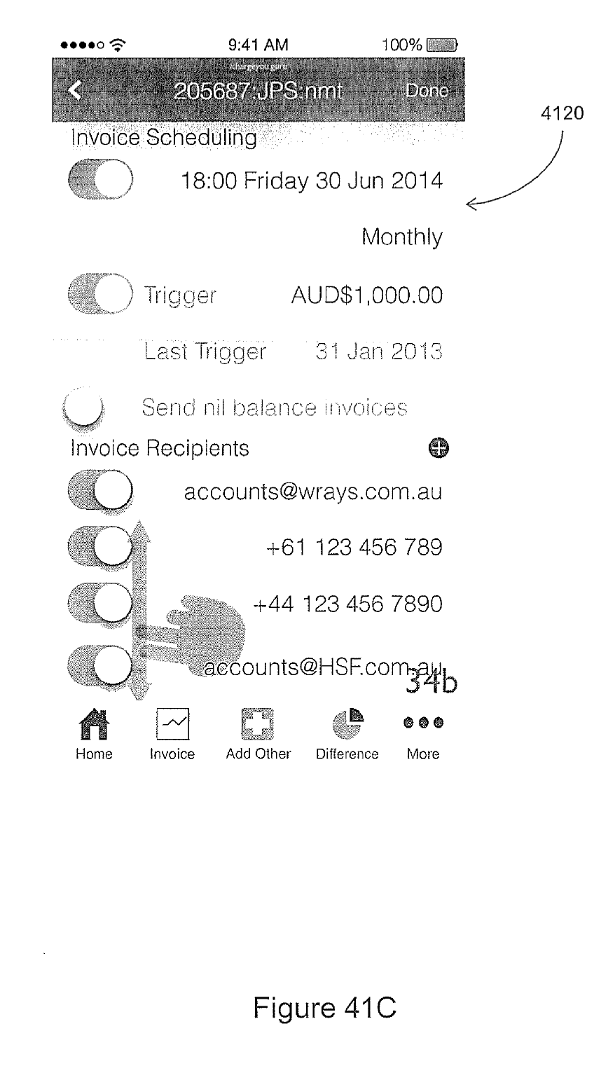

At FIG. 41A to 41C at screens 4100 to 4120, there are shown various settings screens, showing the client or matter specific settings screens.

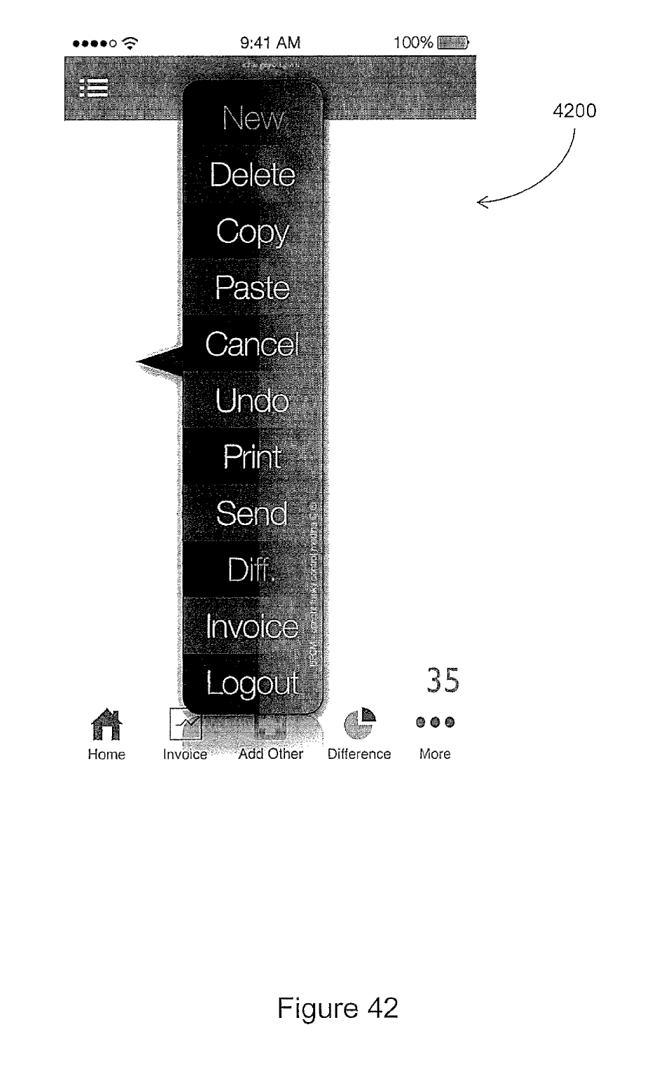

At FIG. 42 at screen 4200, there are shown various settings screens, showing the custom iCY menu and navigation control settings screen.

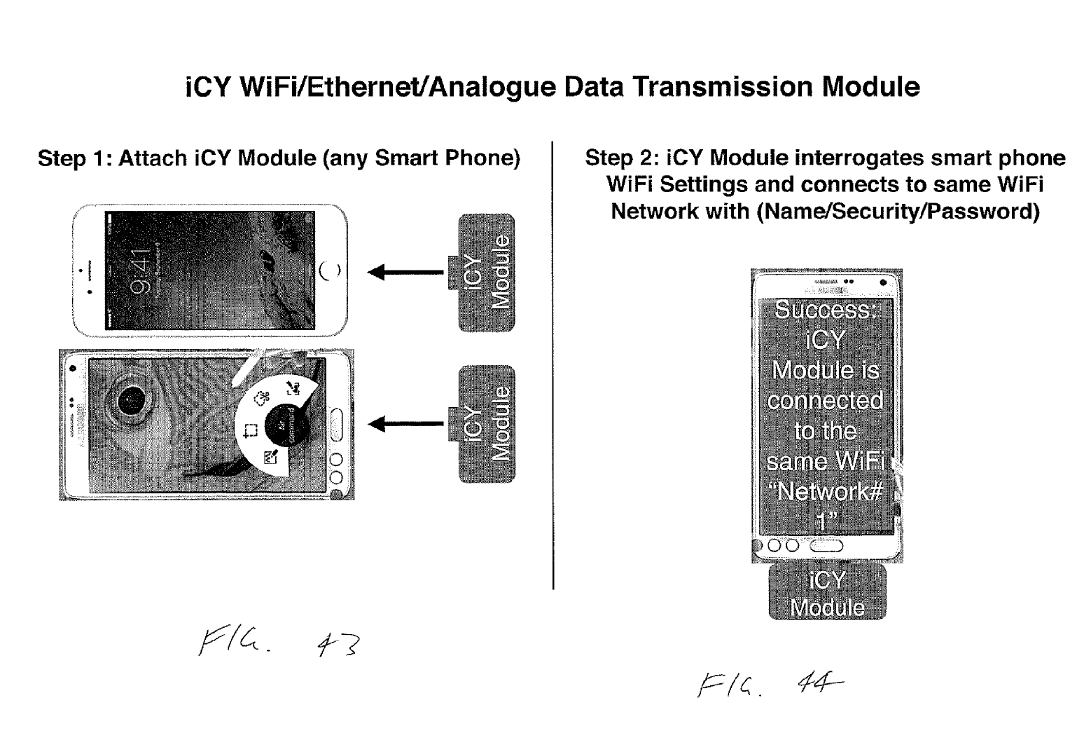

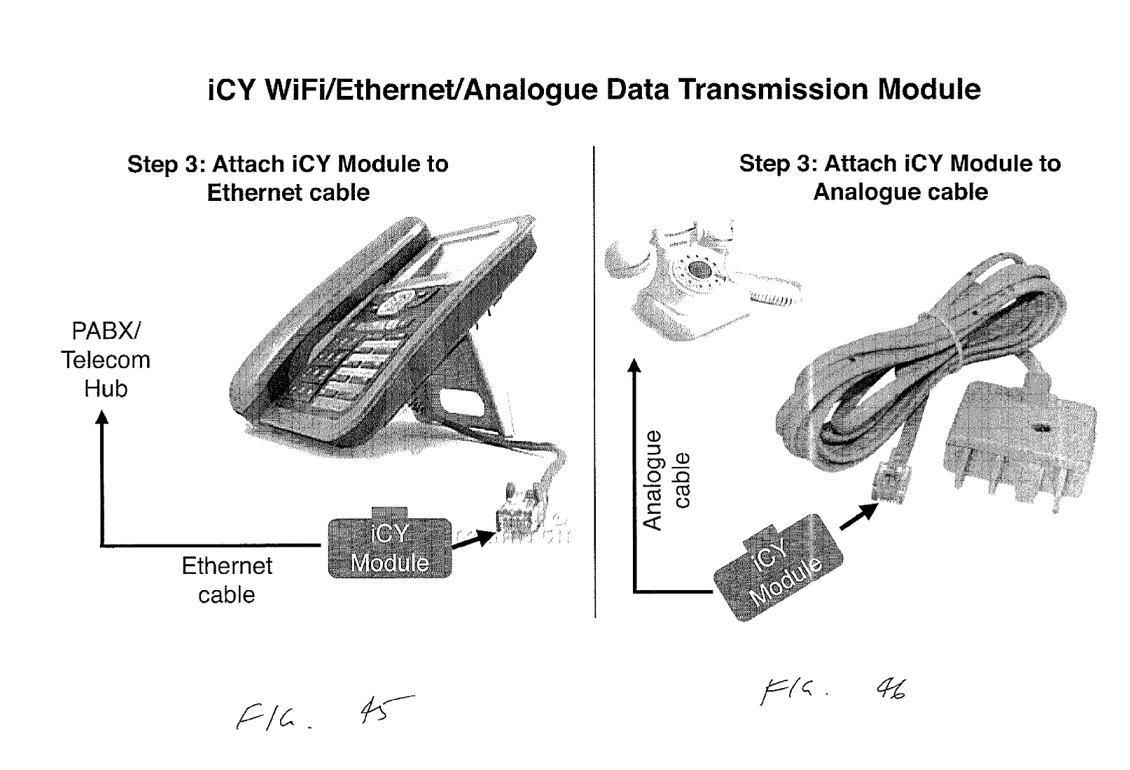

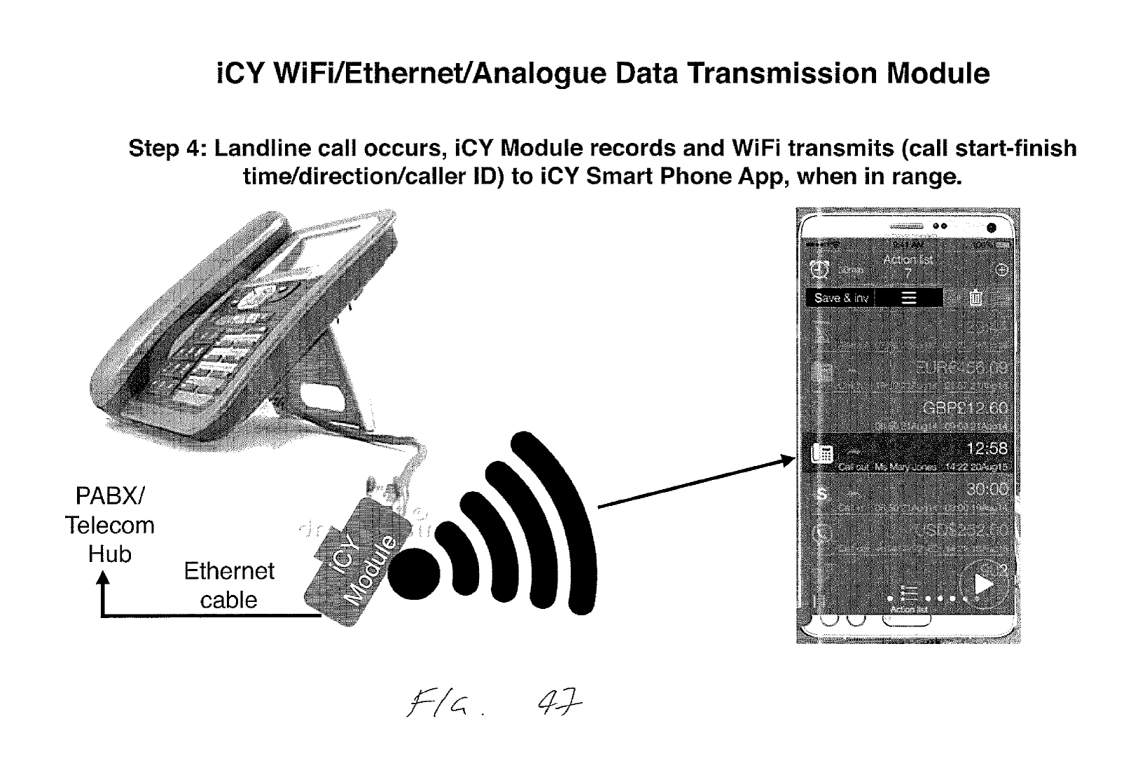

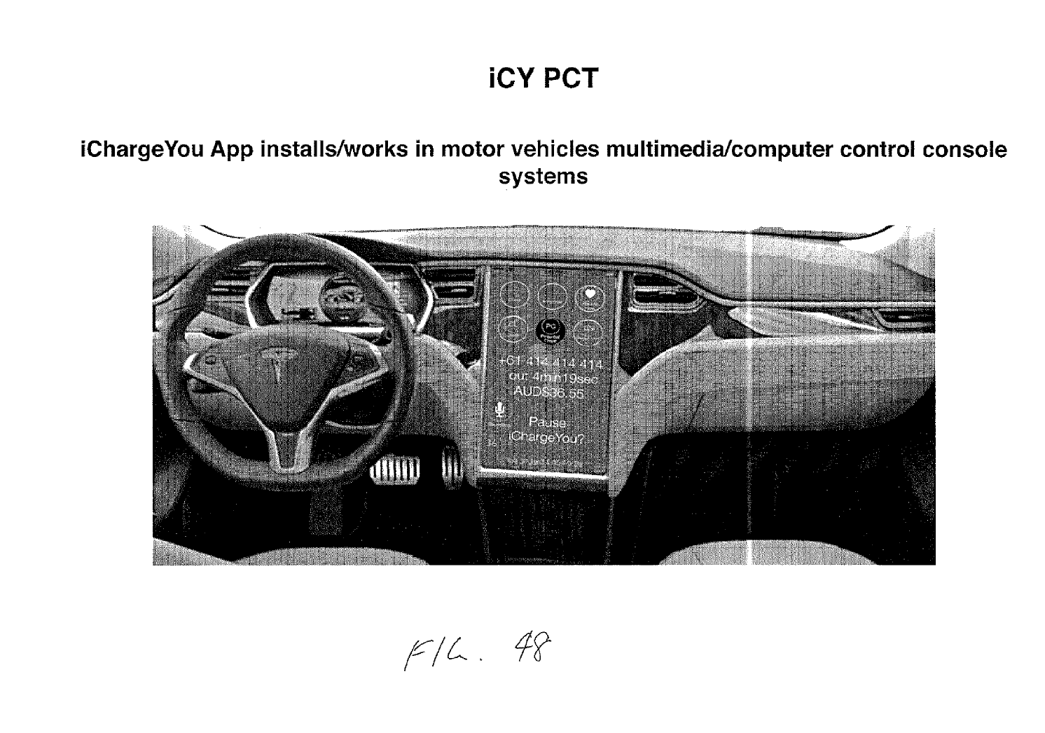

FIGS. 43 to 47 illustrate various method steps of an iCY controller in accordance with an embodiment of the invention.

FIG. 48 illustrates an example of the iCY app, as embedded in a screen in a vehicle.

In the embodiment described herein, the iCY app utilises a hardware event on the device (or iPad/Phablet/laptop/portable computer) to trigger the automatic capturing of call summary, video or email/texting time duration information by the iCY app, either during and/or after an event (such as a call). That is, the iCY app includes an appropriate instruction which monitors for a hardware event on the device, and then begins to capture the event once alerted by the trigger.

For example, on a smartphone, a professional (such as a lawyer) may be carrying the smartphone on their person when they are out of the office. A client may call the professional, causing the professional's smartphone to ring. When the smartphone rings, the iCY app is activated, and begins monitoring to determine whether the professional will answer the call. If the professional answers the call, the app initiates a timer which is arranged to gather information regarding the total time of the conversation (call). In addition, where such information is available (i.e. where ‘caller ID’ technology is available and the client has not blocked their number), the app captures the telephone number associated with the phone call/conversation.

When the caller is not known to the device, or cannot be identified from the contacts available in an unassociated ‘contacts’ application, or the caller number is blocked, the iCY app continues to capture all other collectable call information, so that the professional can attribute or link the call time at the cessation of the call, by typing the party's name, or the matter's reference name, at the cessation of the call. It will be understood that the manual provision of information (e.g. identifying information about the caller) may be input utilising any appropriate interface, including a touchscreen, a keypad, voice and gesture/motion activation or any other mechanism that becomes available from time to time. Such variations are within the purview of a person skilled in the art.

When the iCY app is able to capture the telephone number, the iCY app attempts to identify the caller. This may occur in a number of manners. In one embodiment, the iCY app may access a database of contact names and numbers held in the memory of the smartphone to search for the captured number and for a name that corresponds to the number. In another example, the iCY app may be arranged to connect to a local and/or remote database (e.g. a database held on a server operated or accessible by the professional) to match the incoming number to a name and other relevant information, such as a client number or a file number.

A trigger hardware event may include the commencement of a telephone call via a SIM card or voice/video call over WiFi or an equivalent internet channel or connection. Detection of the commencement of an audio event or a video event may also trigger the iCY app to commence recording the duration of the communication on a mobile phone (iPad/Phablet) style device.

The types of trigger events that are detectable may be dependent on the limitations (hardware or software) of a particular device. For example, on some mobile computing devices, there may be some trigger events (such as the start of a video call) which are not ‘reportable’ and therefore there may be no way for the iCY app to receive any indication that such an event has taken place. In such a situation, the app may include a manual override, which allows the professional to manually ‘trigger’ the app at the time a call is initiated or received, to begin the timer. In this case, it may be necessary for the professional to manually enter an identifier (e.g. a number or a name), to allow the app to associate the time spent during the event with a client.

At the cessation of the audio or video communication, or email/texting communications, the iCY app automatically applies a predetermined professional services rate (for example if the advice provided was Legal Advice, Financial Planning, Construction, Medical, etc.) to the time duration and automatically adds the charge to a client's total charges and also to a log of all previous client and/or matter communications.

In some professional service industries, it is common for one client to have more than one matter with the professional. For example, a law firm may be performing many different legal tasks contemporaneously for a client. Therefore, in one embodiment, the iCY app contains not only information used to identify a client, but also list all matters for the client, so that the professional may associate the event with one or more matters (as required).

Similarly, there may be situations where the professional may wish to split a bill between a number of clients or a number of files. The iCY app also allows the professional to link a call, item or activity to multiple Clients or Contacts and allows the total charge to be replicated across each client, or alternatively split across each client, in any proportions required.

The iCY app may then send the total charge (and optionally all associated transaction information, such as the time and date, etc.) to a remote server, to allow the remote server to generate an invoice for the client. Alternatively, the iCY app may automatically generate an invoice within the app, and send the invoice (and optionally all associated transaction information, such as the time and date, etc.) to the client via any suitable communication means, such as SMS/MMS/email at the nominated time. In one embodiment, where the client prefers to receive a paper copy of the invoice, the invoice may be sent directly to a printer (say, in a mailroom), for automatic printing and mailing to a client.

The iCY app also has the ability to show all calls where amounts have been invoiced, and what calls or amounts have not been invoiced. That is, a historical database of all time entries and invoices are kept. This provides the ability to charge and report a target call and billing revenue amount to an actual amount billed.

Automated Invoice sending may occur via any suitable communication channel, including but not limited to email, SMS, MMS or any other data format: Moreover, invoicing may be triggered automatically when values stored by the database reach a predetermined value, such as:
1. a particular date and/or time (including a particular day of the week);
2. a particular frequency (e.g. ‘once every 10 days’); and/or
3. an accrued balance amount (e.g. ‘invoice automatically when total accrued charges reach $10,000’).

The sending of an invoice may occur automatically (i.e. an invoice is sent without any intervention by the professional) or alternatively, the professional may need to take one or more steps (e.g. clicking a confirmation button) before the invoice is sent.

Where confirmation is required by the professional, an alert may be provided by the app to notify the professional that an invoice is ready to be sent. The professional may then review the invoice and authorise the app to send the invoice.

In addition, where there is either manual or automatic generation of invoices, the app may include one or more standard narrations which the professional may select (or alternatively which the app may select depending on whether the app has received enough contextual information) in order to include a narration on the invoice.

For example, if a professional always uses the same generic narration to describe work done in taking a phone call, then when a phone call is received, the client identified and the time of the call captured, an invoice may be automatically generated, a narration inserted and the invoice sent to the client by email in a matter of seconds.

In more detail, the iCY app may capture additional data and store the data in a local or remote database. The additional data may include, but is not limited to:
1. Date;
2. Time;
3. Start time;
4. Finish time;
5. Duration;
6. Incoming/outgoing phone number;
7. Name if linked to existing Contact;
8. Matter/Professional Advice or opinion;
9. Project or client allocated name for matter; and
10. Organisation Unit, Branch, Section, Contact Name, etc.

There may be some circumstances where a professional may need to pause the phone call (e.g. if the professional needs to consult with a colleague, for example) and may not wish to capture this time as part of the phone call. iCY includes a ‘pause’ function which allows the professional to pause the timer either in-call or during email/document creation to ‘stop the clock’.

It will also be understood that there may be many ways to trigger iCY beyond using a screen interface. Many modern computing devices, including smartphones, include other ways of interacting with the device, such as through voice recognition (such as Apple Siri and Google Voice), facial recognition, distinct device shaking/motion detection, etc. It will be understood that using such techniques, software and/or hardware to activate functions of the iCY app are within the purview of a person skilled in the art.

It will also be understood that the iCY app includes customisable features and the embodiment described herein includes a number of features that allow for very specific customisation, at a client level or at a matter level. For example, clients residing in different jurisdictions or geographical regions, may require different tax rates to be applied. In addition, iCY data can be aggregated into different user groups. For example within an organisation, different employee reporting groups exist and there may be a requirement to report billings or invoiced amounts by group rather than by individual.

Therefore, ICY includes the ability to create a client profile, and also a matter profile, which allows for the customisation of the following quantities (which are described here merely as examples and are not intended to limit the scope of the invention):
1. Tax rate;
2. Time/Date rate (i.e. different hourly charges depending on the time of the day and the date/day of the week);
3. Currency; and
4. Special flat rate.

In addition, there may be charges that are not directly related to a trigger event (such as a phone call) that a professional may want to capture. For example, a lawyer travelling to the Lands Office to file some papers or purchase some documents, may want to capture travelling time plus any official disbursements (i.e. costs paid by the professional) to file or secure copies of any original documents.

The iCY app allows the user to record any other type of transaction or billable amount that could be invoiced. As this aspect of the iCY app allows a professional to input information in any way they wish, any type of billable item may be included and is confined only to the imagination of the person that enters the information. For example, mechanics can record iCY items as is done in a traditional spread sheet program such as Microsoft Excel™. In another example, Legal Professionals can record photocopying fees or back office costs at either the Matter or Client level.

The app may optionally provide a mechanism by which referral payments may be made. Existing users of the iCY app may send the iCY server-side database the first name, last name and email address of the referred potential customer. The sent information is then reconciled with the information provided from Apple™ App store and Google™ Play store against new purchases of iCY. Where new purchases are successfully matched, then the user who referred that purchasing customer is automatically paid a referral incentive payment.

The iCY app may also generate reports and charts in any appropriate format, such as line graphs, pie graphs, bar graphs and area graphs, depending on the requirements of a particular professional. This allows the professional to compare billing in a Weekly, Fortnightly, Monthly or Quarterly fashion, and divide by calendar year, financial year, or any custom period of time as required by a professional. Of course, it is also possible to compare over time (historical reviews) as well as reviewing invoiced amount.

The app may also include a series of custom controls, including touch and hold buttons for commonly used functions, such as:
1. Creating a new invoice/client/matter;
2. Deleting an invoice/client/matter;
3. Copying and Pasting data from one field to another field;
4. Cancelling or Undoing actions;
5. Printing and/or Sending data; and/or
6. Generating an invoice.

The iCY app may also be arranged to export files electronically to one or more Export to Vendor/Import from software products such as Aderant™, Inprotech™, Attache™, MYOB™, Reckon™, Sage MicOPay™, Xero™ and/or any other suitable accounting software.

It will also be understood that the iCY app can import the names of Clients and Matters from other accounting or software applications with client information. For example, when client names, matter names or project names and not presently found in the iCY app, iCY can import them from a spread sheet or comma delimited file. Alternatively, if such information is not available in an electronic format, the iCY app allows the user to create a new client name or matter name on the fly, by using the interface on the mobile device, when the correct name cannot be found to attribute or link the potentially billable time duration or invoice item. Similarly, iCY enables recording of all iCY user calls, into a Timesheet. Timesheet's can be daily, weekly or for any custom period.

The information exported and/or imported may include clients and billable matters/items e.g. legal matters, project items, discrete items that attract charges e.g. medical, construction, et al.

In one embodiment, the app may include a Record Client Verification/Consent to the purported duration of advice or professional services: The professional may ask the client to provide Storing Fingerprint, Signature, Verbal agreement, SMS, file as evidence of consent of timesheet or accepted charges.

### iCY Controller

In one embodiment, there is provided a separate device (referred to herein as the iCY Digital and Analogue Phone Call Controller Device (“iCY Controller”)), which acts as a ‘dongle’ to capture call events. The iCY controller is a self-contained embedded Wi-Fi® device with an integrated MAC, baseband processor, RF transceiver and power amplifier. The iCY controller's MAC/baseband processor, provides all the WLAN protocol, configuration functionality and TCP/IP stack in embedded firmware to allow the controller to operate as a self contained serial to wireless device for ultra low power WLAN applications. It conforms to the current WiFi 802.11n/ac standards, and includes an embedded processor with UART and SPI as host interfaces.

The iCY module has a number of hardware ports including a micro USB (or equivalent) port, an Ethernet port, and/or an Apple compatible port. The embedded firmware is also arranged to include an API which allows the device to physically connect to corresponding ethernet and/or analogue cabling, which allows it to interface with incoming and outgoing telephone calls, made with a landline handset or any Smart Phone data port.

In more detail, the API enables the controller to detect all digital and analogue signals (phone calls), transmitted through the ethernet or analogue line/cable to thereby detect the initiation of a call and to record one or more types of information, including but not limited to a) Call direction b) Caller ID c) Call start time, Call end time. The controller has suitable memory, such as RAM, to save/store all data until successfully transmitted to the iCY App Smart Phone’

Any iCY App installed on any Smart Phone works with any iCY controller, However, an iCY controller will only transmit data to ONE iCY App for the duration of the WiFi connection to one Smart Phone. Any iCY App Smart Phone, can be unlinked, and any other iCY App Smart Phone can be paired to the iCY controller. That is, one to one relationship/pairing at a time.

The controller further includes a Switch for WiFi (default) or WiFi-direct, transmission and an LED indicator.

Referring to FIGS. 43 to 47, there is shown a flowchart of how the controller operates in practice. Where the device is connected to a VOIP “land line” telephone, at Step 1: The Smart Phone has an active working WiFi connection, and when Smart Phone is in WiFi range of user's landline handset (in Office or Home) the controller connects with the smart phone in real time. Step 2: The controller is physically plugged into data port on any Smart Phone. Step 3: The controller interrogates the Smart Phone WiFi settings, duplicates them, and connects to that same WiFi network. Step 4: The user detaches the iCY Controller from Smart Phone, and attaches to a landline ethernet, such that it intercepts and permits ethernet VOIP/digital phone call to the landline handset. Step 5: the iCY Controller stores landline data (Caller Id, call start time, call end time, Call direction (in/out)) Step 6: When Smart Phone is in WiFi network range, the iCY Controller transmits all captured landline data to iCY App Action List. Step 7: iCY Controller can be spontaneously detached, and relocated to any other VOIP ethernet/WiFi environment, and work after it is successfully paired to the Smart Phone, in that new WiFi network.

At step 1b there is shown an analogue embodiment which operates using the same process and features as digital landline calls.

### Additional Features

All iCY Users can share all iCY data, on their Smart Phone with any other iCY users Smart Phone, if permission is granted to the requesting party, by the data owner (other iCY user). iCY data is sent via, Wifi, NFC or email or USB style memory stick import, to requesting iCY user, e.g. by the first users manager, or reporting team member.

In some embodiments, there may be provided additional features which allow use by specialised professions. For example, the iCY app may include appropriate ledgers and may comply with national or state requirements to allow the iCY app to operate as a lawyer's Trust Account. Such additions may include the ability to record alternative Trust Account or Bank Account running balance totals with iCY Receipt amounts automatically recorded in Trust Account running balance.

Similarly, the iCY app may be capable of recording invoice payments and debtors—that is, link any outstanding invoice, to any corresponding receipt or payment made and/or show any invoice and invoice amounts, as fully paid, partly paid, not paid paid. Such variations are within the purview of a person skilled in the art.

The iCY app may also include user (lawyer/advisor/product or service provider) payment processing support—iCY User's Clients (lawyers client), can complete Invoice Payments for work for which they were the beneficiary, from the iCY Users (lawyer/advisor/product or service provider) Smart Phone (the Invoice Senders Smart Phone).

In addition, in some embodiments, Invoice Recipient Payments may be enabled by generating invoices that include embedded links to available payment gateways, to settle any outstanding invoice amounts. Again, such variations are within the purview of a person skilled in the art.

The iCY app may also include User Profile Support, which records important government business identification data, such as for taxation reporting (ABN, ACN, Bank Acc BSB), Revenue Target Comparison support via comparing GDP, Inflation, Stock and Bond Market annual rates of return, to iCY users annual earnings rate of return, and iCY users organisation annual earnings and annual tax paid.

### Alterations and Modifications to the Embodiments

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

It will be understood that while the embodiment described herein has been described with reference to a ‘smartphone’, there are various other devices which could equally be utilised to implement embodiments of the invention. For example, the use of Google Glass™ plus other similar ‘smart’ devices could utilise embodiments of the invention to perform substantially similar or identical functions to the functions carried out by the embodiment and broader invention described herein. Such variations are within the purview of a person skilled in the art and are encompassed by the claimed invention.

Although not required, the embodiments described with reference to the Figures can be implemented as an Application Programming Interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by a computing system or partly implemented by computing systems then any appropriate computing system architecture may be utilised. This will include stand-alone computers, network computers and dedicated hardware devices, such as programmable arrays. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A device for monitoring an interaction, comprising an identification module arranged to monitor events on a hardware device to determine a trigger for an event, wherein, on determining the trigger for the event, a timer module is arranged to monitor for completion of the event, and upon completion of the event, the timer module records the total time of the event in an event record.

2. A device in accordance with claim 1, further including an identification module arranged to identify a party associated with the event, wherein, upon completion of the event, information regarding the party associated with the event is recorded in the event record.

3. A device in accordance with claim 2, wherein the timer module further records at least one of a start time for the event, an end time for the event, a start date of the event, an end date of the event and information about the initiator of the call in the event record.

4. A device in accordance with claim 2, wherein the identification module also identifies a reference identifier associated with the party, wherein, upon completion of the event, the reference associated with the party is recorded in the event record.

5. A device in accordance with claim 4, wherein the identification module identifies a plurality of reference identifiers associated with a party and provides the reference identifiers to a user of the device, wherein upon selection of one or more of the plurality of reference identifiers by the user, the identification module associates and records the one or more reference identifiers in the event record.

6. A device in accordance with claim 1, further including a charge module arranged to utilise information recorded by the timer module to generate an amount of billable time, wherein the billable time is recorded and associated with the event record.

7. A device in accordance with claim 6, further including an invoicing module arranged to utilise the billable time recorded in the event record to generate an invoice.

8. A device in accordance with claim 7, wherein the invoicing module is arranged to forward, via a communications module, the invoice to a remote device.

9. A device in accordance with claim 1, further including a human machine interface arranged to allow a user of the device to interact with the device.

10. A device in accordance with claim 9, wherein the human machine interface is a touchscreen.

11. A device in accordance with claim 1, where the device is a mobile communications device, such as a smartphone.

12. A system for monitoring an interaction, comprising a device including an trigger detection module arranged to monitor events on a hardware device to determine a trigger for an event, wherein, on determining the trigger for the event, the trigger detection module invokes a timer module arranged to monitor for completion of the event, and upon completion of the event, the timer module records the total time of the event in an event record.

13. A system in accordance with claim 12, wherein the timer module and the trigger detection module are located on the device.

14. A system in accordance with claim 12, further including an identification module arranged to identify a party associated with the event, wherein, upon completion of the event, information regarding the party associated with the event is recorded in the event record.

15. A system in accordance with claim 12, wherein the timer module further records at least one of a start time for the event, an end time for the event, a start date of the event, an end date of the event and information about the initiator of the call in the event record.

16. A system in accordance with claim 13, wherein the identification module also identifies a reference identifier associated with the party, wherein, upon completion of the event, the reference associated with the party is recorded in the event record.

17. A system in accordance with claim 16, wherein the identification module identifies a plurality of reference identifiers associated with a party and provides the reference identifiers to a user of the device, wherein upon selection of one or more of the plurality of reference identifiers by the user, the identification module associates and records the one or more reference identifiers in the event record.

18. A system in accordance with claim 12, further including a charge module arranged to utilise information recorded by the timer module to generate an amount of billable time, wherein the billable time is recorded and associated with the event record.

19. A system in accordance with claim 18, further including an invoicing module arranged to utilise the billable time recorded in the event record to generate an invoice.

20. A system in accordance with claim 19, wherein the invoicing module is arranged to forward, via a communications module, the invoice to a remote device.

21. A system in accordance with claim 12, further including a human machine interface arranged to allow a user of the device to interact with the module.

22. A system in accordance with claim 22, wherein the human machine interface is a touchscreen.

23. A system in accordance with claim 12, where the device is a mobile communications device, such as a smartphone.

24. A method for monitoring an interaction, comprising the steps of utilising an identification module arranged to monitor events on a hardware device to determine a trigger for an event, wherein, on determining the trigger for the event, a timer module is arranged to monitor for completion of the event, and upon completion of the event, the timer module records the total time of the event in an event record.

25-36. (canceled)

37. A device in accordance with claim 3, wherein the identification module also identifies a reference identifier associated with the party, wherein, upon completion of the event, the reference associated with the party is recorded in the event record.
